(19) United States
(12) Patent Application Publication
(10) Pub. No.: US 2024/0340990 A1
(43) Pub. Date: Oct. 10, 2024

(54) MEDIUM ACCESS CONTROL SIGNALING TRIGGERING TRANSMISSION CONFIGURATION INDICATOR STATE UPDATE AND BEAM MEASUREMENT OR REPORT

(71) Applicant: QUALCOMM Incorporated, San Diego, CA (US)

(72) Inventors: Tianyang BAI, Mountain View, CA (US); Yan ZHOU, San Diego, CA (US); Fang YUAN, Beijing (CN); Tao LUO, San Diego, CA (US); Junyi LI, Fairless Hills, PA (US)

(21) Appl. No.: 18/574,505

(22) PCT Filed: Aug. 20, 2021
(86) PCT No.: PCT/CN2021/113722

§ 371 Date: Dec. 27, 2023

(51) Int. Cl. H04W 76/20; H04L 5/00; H04W 24/10; H04W 80/02

(52) U.S. Cl. CPC H04W 76/20; H04L 5/0051; H04W 24/10; H04W 80/02

(57) ABSTRACT

Various aspects of the present disclosure generally relate to wireless communication. In some aspects, a user equipment (UE) may receive, via medium access control (MAC) signaling, an indication to activate one or more transmission configuration indicator (TCI) states for the UE, wherein the indication triggers at least one of a measurement of a reference signal or a transmission of a measurement report for at least one TCI state of the one or more TCI states, wherein the reference signal or the transmission of the measurement report is triggered based on an association of a TCI state with the reference signal or the measurement report. The UE may receive the reference signal based on receiving the indication to activate the one or more TCI states. The UE may transmit the measurement report based on the indication triggering the transmission of the measurement report. Numerous other aspects are provided.

### FIELD OF THE DISCLOSURE

Aspects of the present disclosure generally relate to wireless communication and specifically, to techniques and apparatuses for medium access control (MAC) signaling triggering a transmission configuration indicator (TCI) state update and a beam measurement or report.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In some cases, a base station may update a beam to be used by a user equipment (UE). For example, the base station may transmit, to the UE, an indication to switch a beam used by the UE to a new beam (for example, by activating one or more transmission configuration indicator (TCI) states). A beam measurement or associated reporting of beam measurement(s) by a UE may be triggered by the base station transmitting a message to the UE. For example, the base station may transmit downlink control information (DCI) or a medium access control (MAC) control element (MAC-CE) message triggering a beam measurement or a measurement report. In some cases, it may be beneficial for a UE to measure a beam after a beam switch or a beam update. For example, the UE may measure or report measurements of a new beam (for example, after receiving a beam switch indication or a beam update) to the base station. The beam measurement and associated reporting may enable the base station to make improved beam management determinations. However, to trigger a beam switch or a beam update and to trigger the UE to transmit a measurement report, the base station may have to transmit multiple messages to the UE. For example, the base station may transmit a first message to trigger the beam switch or the beam update. The base station may transmit a second message to trigger the beam measurement or the measurement report. This may consume resources associated with transmitting the multiple messages to trigger a beam switch and to trigger the beam measurement or the measurement report.

### SUMMARY

Some aspects described herein relate to a user equipment (UE) for wireless communication. The user equipment may include at least one processor and at least one memory, communicatively coupled with the at least one processor, that stores processor-readable code. The processor-readable code, when executed by the at least one processor, may be configured to cause the user equipment to receive, via medium access control (MAC) signaling, an indication to activate one or more transmission configuration indicator (TCI) states for the UE, wherein the indication triggers at least one of a measurement of a reference signal or a transmission of a measurement report for at least one TCI state of the one or more TCI states, wherein the reference signal or the transmission of the measurement report is triggered based at least in part on an association of a TCI state, from the at least one TCI state, with the reference signal or the measurement report. The processor-readable code, when executed by the at least one processor, may be configured to cause the user equipment to receive the reference signal based at least in part on receiving the indication to activate the one or more TCI states. The processor-readable code, when executed by the at least one processor, may be configured to cause the user equipment to transmit the measurement report based at least in part on the indication triggering the transmission of the measurement report, wherein the measurement report indicates a measurement of the reference signal.

Some aspects described herein relate to a base station for wireless communication. The base station may include at least one processor and at least one memory, communicatively coupled with the at least one processor, that stores processor-readable code. The processor-readable code, when executed by the at least one processor, may be configured to cause the base station to transmit, to a UE via MAC signaling, an indication to activate one or more TCI states for the UE, wherein the indication triggers at least one of a measurement of a reference signal or a transmission of a measurement report by the UE for at least one TCI state of the one or more TCI states, wherein the reference signal or the transmission of the measurement report is triggered based at least in part on an association of a TCI state, from the at least one TCI state, with the reference signal or the measurement report. The processor-readable code, when executed by the at least one processor, may be configured to cause the base station to transmit the reference signal based at least in part on transmitting the indication to activate the one or more TCI states. The processor-readable code, when executed by the at least one processor, may be configured to cause the base station to receive the measurement report based at least in part on the indication triggering the transmission of the measurement report, wherein the measurement report indicates a measurement of the reference signal.

Some aspects described herein relate to a method of wireless communication performed by a UE. The method may include receiving, via MAC signaling, an indication to activate one or more TCI states for the UE, wherein the indication triggers at least one of a measurement of a reference signal or a transmission of a measurement report for at least one TCI state of the one or more TCI states, wherein the reference signal or the transmission of the measurement report is triggered based at least in part on an association of a TCI state, from the at least one TCI state, with the reference signal or the measurement report. The method may include receiving the reference signal based at least in part on receiving the indication to activate the one or more TCI states. The method may include transmitting the measurement report based at least in part on the indication triggering the transmission of the measurement report, wherein the measurement report indicates a measurement of the reference signal.

Some aspects described herein relate to a method of wireless communication performed by a base station. The method may include transmitting, to a UE via MAC signaling, an indication to activate one or more TCI states for the UE, wherein the indication triggers at least one of a measurement of a reference signal or a transmission of a measurement report by the UE for at least one TCI state of the one or more TCI states, wherein the reference signal or the transmission of the measurement report is triggered based at least in part on an association of a TCI state, from the at least one TCI state, with the reference signal or the measurement report. The method may include transmitting the reference signal based at least in part on transmitting the indication to activate the one or more TCI states. The method may include receiving the measurement report based at least in part on the indication triggering the transmission of the measurement report, wherein the measurement report indicates a measurement of the reference signal.

Some aspects described herein relate to a non-transitory computer-readable medium that stores a set of instructions for wireless communication by a UE. The set of instructions, when executed by one or more processors of the UE, may cause the UE to receive, via MAC signaling, an indication to activate one or more TCI states for the UE, wherein the indication triggers at least one of a measurement of a reference signal or a transmission of a measurement report for at least one TCI state of the one or more TCI states, wherein the reference signal or the transmission of the measurement report is triggered based at least in part on an association of a TCI state, from the at least one TCI state, with the reference signal or the measurement report. The set of instructions, when executed by one or more processors of the UE, may cause the UE to receive the reference signal based at least in part on receiving the indication to activate the one or more TCI states. The set of instructions, when executed by one or more processors of the UE, may cause the UE to transmit the measurement report based at least in part on the indication triggering the transmission of the measurement report, wherein the measurement report indicates a measurement of the reference signal.

Some aspects described herein relate to a non-transitory computer-readable medium that stores a set of instructions for wireless communication by a base station. The set of instructions, when executed by one or more processors of the base station, may cause the base station to transmit, to a UE via MAC signaling, an indication to activate one or more TCI states for the UE, wherein the indication triggers at least one of a measurement of a reference signal or a transmission of a measurement report by the UE for at least one TCI state of the one or more TCI states, wherein the reference signal or the transmission of the measurement report is triggered based at least in part on an association of a TCI state, from the at least one TCI state, with the reference signal or the measurement report. The set of instructions, when executed by one or more processors of the base station, may cause the base station to transmit the reference signal based at least in part on transmitting the indication to activate the one or more TCI states. The set of instructions, when executed by one or more processors of the base station, may cause the base station to receive the measurement report based at least in part on the indication triggering the transmission of the measurement report, wherein the measurement report indicates a measurement of the reference signal.

Some aspects described herein relate to an apparatus for wireless communication. The apparatus may include means for receiving, via MAC signaling, an indication to activate one or more TCI states for the apparatus, wherein the indication triggers at least one of a measurement of a reference signal or a transmission of a measurement report for at least one TCI state of the one or more TCI states, wherein the reference signal or the transmission of the measurement report is triggered based at least in part on an association of a TCI state, from the at least one TCI state, with the reference signal or the measurement report. The apparatus may include means for receiving the reference signal based at least in part on receiving the indication to activate the one or more TCI states. The apparatus may include means for transmitting the measurement report based at least in part on the indication triggering the transmission of the measurement report, wherein the measurement report indicates a measurement of the reference signal.

Some aspects described herein relate to an apparatus for wireless communication. The apparatus may include means for transmitting, to a UE via MAC signaling, an indication to activate one or more TCI states for the UE, wherein the indication triggers at least one of a measurement of a reference signal or a transmission of a measurement report by the UE for at least one TCI state of the one or more TCI states, wherein the reference signal or the transmission of the measurement report is triggered based at least in part on an association of a TCI state, from the at least one TCI state, with the reference signal or the measurement report. The apparatus may include means for transmitting the reference signal based at least in part on transmitting the indication to activate the one or more TCI states. The apparatus may include means for receiving the measurement report based at least in part on the indication triggering the transmission of the measurement report, wherein the measurement report indicates a measurement of the reference signal.

Aspects generally include a method, apparatus, system, computer program product, non-transitory computer-readable medium, user equipment, base station, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example base station in communication with a user equipment (UE) in a wireless network in accordance with the present disclosure.

FIG. 3 is a diagram illustrating an example of physical channels and reference signals in a wireless network, in accordance with the present disclosure.

FIG. 4 is a diagram illustrating examples of channel state information (CSI) reference signal (CSI-RS) beam management procedures, in accordance with the present disclosure.

FIG. 5 is a diagram illustrating an example associated with medium access control (MAC) signaling triggering a transmission configuration indicator (TCI) state update or activation and a beam measurement or report, in accordance with the present disclosure.

FIG. 6 is a flowchart illustrating an example process performed, for example, by a UE associated with MAC signaling triggering a TCI state update or activation and a beam measurement or report, in accordance with the present disclosure.

FIG. 7 is a flowchart illustrating an example process performed, for example, by a base station associated with MAC signaling triggering a TCI state update or activation and a beam measurement or report, in accordance with the present disclosure.

FIGS. 8 and 9 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to medium access control (MAC) signaling (for example, MAC control element (MAC-CE) signaling) triggering a transmission configuration indicator (TCI) state update (or a beam update) and a beam measurement or measurement report. Some aspects more specifically relate to a MAC-CE message, that activates one or more TCI states, triggering a measurement of a reference signal or a transmission of a measurement report (for example, by a user equipment (UE)) for at least one TCI state of the one or more TCI states. For example, a MAC-CE message may indicate one or more TCI states to be activated by the UE. At least one TCI state, of the one or more TCI states, may be associated with, or linked with, one or more trigger states, one or more reporting configurations, or one or more beam measurement procedures to be performed by the UE. Therefore, when the UE receives the MAC-CE message that activates the one or more TCI states, the UE may also be triggered to perform measurements or to transmit a measurement report.

In some aspects, a configuration or determination of an association between TCI states and reference signal resource sets or measurement report configurations may be provided. In some aspects, the MAC-CE message that activates the one or more TCI states and that triggers the UE to perform measurements or to transmit a measurement report may include an indication of the association between TCI states and reference signal resource sets or measurement report configurations. In some aspects, the association between TCJ states and reference signal resource sets or measurement report configurations may be based at least in part on signaling (for example, the MAC-CE message or another message, such as a radio resource control (RRC) message) that configures the association. In some other aspects, the association between TCI states and reference signal resource sets or measurement report configurations may be based at least in part on one or more rules.

Particular aspects of the subject matter described in this disclosure can be implemented to realize one or more of the following potential advantages. In some examples, the described techniques can be used to activate one or more TCI states and trigger the UE to perform measurements or to transmit a measurement report associated with at least one TCI state in the same message (for example, in a single message). This may conserve resources that would have otherwise been used to transmit multiple messages to activate the one or more TCI states and to trigger the beam measurement or the measurement report. In some examples, the described techniques can be used to activate one or more TCI states, to indicate an association between TCI states and reference signal resource sets or measurement report configurations, and trigger the UE to perform measurements or to transmit a measurement report associated with at least one TCI state in the same message (for example, in a single message). This may conserve resources that would have otherwise been used to transmit multiple messages to configure the association between TCI states and reference signal resource sets or measurement report configurations, to activate the one or more TCI states, and to trigger the beam measurement or the measurement report. In some examples, the described techniques can be used to activate multiple TCJ states and to trigger the UE to perform measurements or to transmit a measurement report associated with one or more (or all) of the multiple TCJ states. This provides additional flexibility for the base station by enabling the base station to activate multiple TCJ states and to trigger one or more beam measurements (by the UE) or one or more measurement reports in the same message (for example, in a single message).

In some examples, the described techniques can be used to reduce a latency associated with activating a TCJ state. For example, if a TCJ state is activated using a message, the UE may receive the message (for example, a MAC-CE) activating the TCJ state, may receive a synchronization signal block (SSB) that is associated with the TCJ state (for example, to receive some information associated with the TCI state), and may activate the TCI state an amount of time after receiving the SSB. However, SSBs are transmitted periodically and a time to a next SSB (after receiving the message activating the TCI state) may be significant. In some examples, the described techniques can be used to activate a TCI state and to trigger a measurement of a reference signal by the UE in the same message. A timing offset between the message and a transmission of the reference signal may be less than a time between the message an a next SSB associated with the TCI state. Therefore, the UE may be enabled to measure the reference signal (for example, to receive some information associated with the TCI state) and may activate the TCI state sooner than if the UE waited to receive the next SSB associated with the TCI state. Additionally, in some examples, the described techniques can be used to support a configuration of multiple actions (for example, multiple beam measurements or measurement reports) using a single triggering message, which improves flexibility of concurrent triggering of beam switch and measurement or measurement reporting.

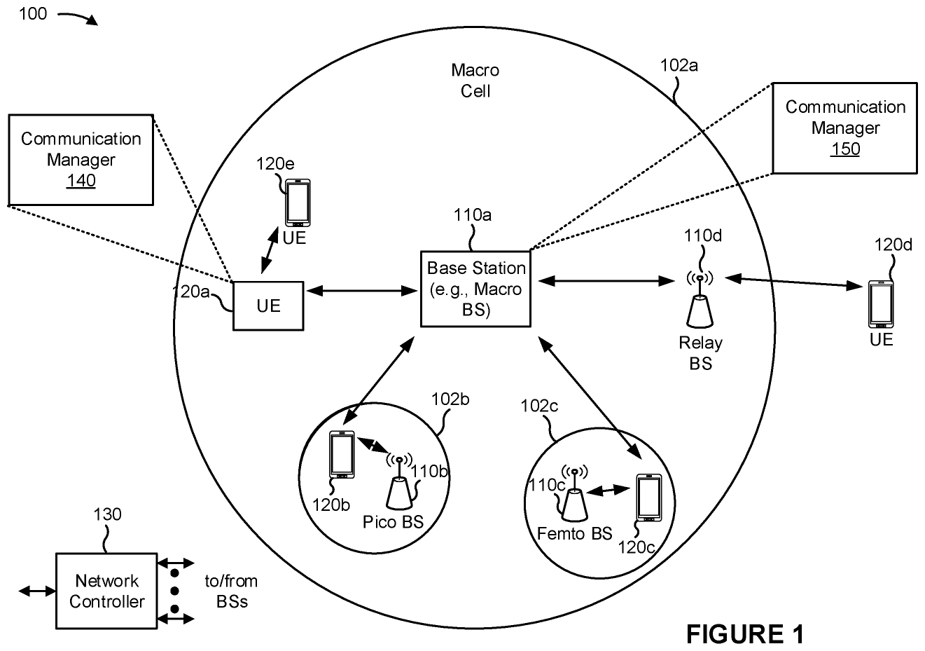

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more base stations 110 (shown as a BS 110a, a BS 110b, a BS 110c, and a BS 110d), a UE 120 or multiple UEs 120 (shown as a UE 120a, a UE 120b, a UE 120c, a UE 120d, and a UE 120e), or other network entities. A base station 110 is an entity that communicates with UEs 120. A base station 110 (sometimes referred to as a BS) may include, for example, an NR base station, an LTE base station, a Node B, an eNB (for example, in 4G), a gNB (for example, in 5G), an access point, or a transmission reception point (TRP). Each base station 110 may provide communication coverage for a particular geographic area. In the Third Generation Partnership Project (3GPP), the term “cell” can refer to a coverage area of a base station 110 or a base station subsystem serving this coverage area, depending on the context in which the term is used.

A base station 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station.

The wireless network 100 may be a heterogeneous network that includes base stations 110 of different types, such as macro base stations, pico base stations, femto base stations, or relay base stations. These different types of base stations 110 may have different transmit power levels, different coverage areas, or different impacts on interference in the wireless network 100. For example, macro base stations may have a high transmit power level (for example, 5 to 40 watts) whereas pico base stations, femto base stations, and relay base stations may have lower transmit power levels (for example, 0.1 to 2 watts). In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (for example, three) cells. A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

In some examples, a cell may not necessarily be stationary, and the geographic area of the cell may move in accordance with the location of a base station 110 that is mobile (for example, a mobile base station). In some examples, the base stations 110 may be interconnected to one another or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a base station 110 or a UE 120) and send a transmission of the data to a downstream station (for example, a UE 120 or a base station 110). A relay station may be a UE 120 that can relay transmissions for other UEs 120. In the example shown in FIG. 1, the BS 110d (for example, a relay base station) may communicate with the BS 110a (for example, a macro base station) and the UE 120d in order to facilitate communication between the BS 110a and the UE 120d. A base station 110 that relays communications may be referred to as a relay station, a relay base station, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a base station, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the base station 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive, via MAC signaling, an indication to activate one or more TCI states for the UE, wherein the indication triggers at least one of a measurement of a reference signal or a transmission of a measurement report for at least one TCI state of the one or more TCI states, wherein the reference signal or the transmission of the measurement report is triggered based at least in part on an association of a TCI state, from the at least one TCI state, with the reference signal or the measurement report; receive the reference signal based at least in part on receiving the indication to activate the one or more TCI states; and transmit the measurement report based on the indication triggering the transmission of the measurement report, wherein the measurement report indicates a measurement of the reference signal. Additionally or alternatively, the communication manager 140 may perform one or more other operations described herein.

In some aspects, the base station 110 may include a communication manager 150. As described in more detail elsewhere herein, the communication manager 150 may transmit, to a UE 120 via MAC signaling, an indication to activate one or more TCI states for the UE, wherein the indication triggers at least one of a measurement of a reference signal or a transmission of a measurement report by the UE for at least one TCI state of the one or more TCI states, wherein the reference signal or the transmission of the measurement report is triggered based at least in part on an association of a TCI state, from the at least one TCI state, with the reference signal or the measurement report; transmit the reference signal based at least in part on transmitting the indication to activate the one or more TCI states; and receive the measurement report based on the indication triggering the transmission of the measurement report, wherein the measurement report indicates a measurement of the reference signal. Additionally or alternatively, the communication manager 150 may perform one or more other operations described herein.

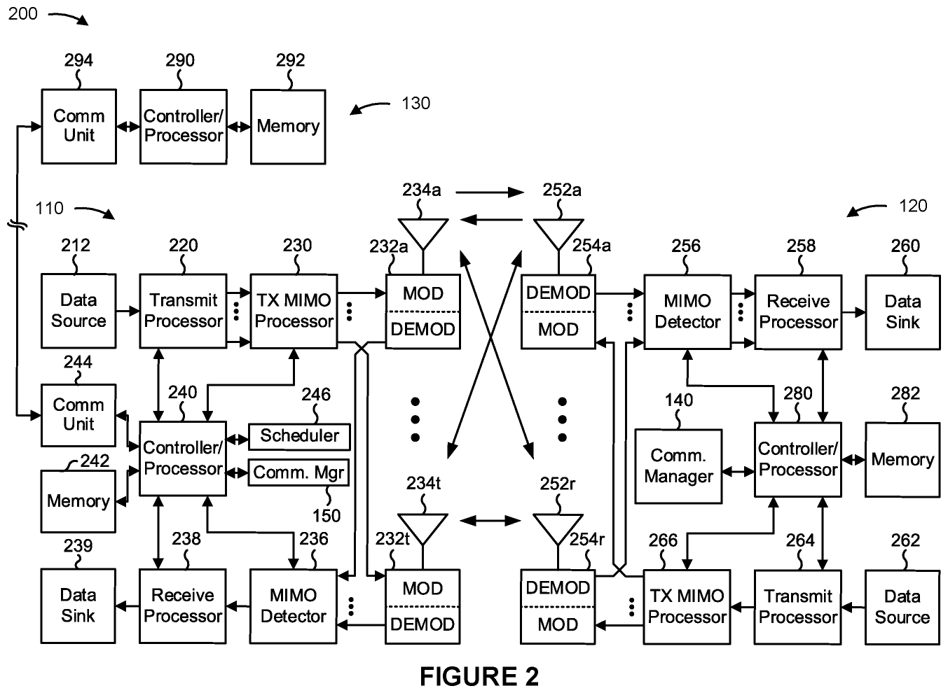

FIG. 2 is a diagram illustrating an example base station in communication with a UE in a wireless network in accordance with the present disclosure. The base station may correspond to the base station 110 of FIG. 1. Similarly, the UE may correspond to the UE 120 of FIG. 1. The base station 110 may be equipped with a set of antennas 234a through 234t, such as T antennas (T>1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, Tmodems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the base station 110 or other base stations 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols.

A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the base station 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244.

The base station 110 may include a scheduler 246 to schedule one or more UEs 120 for downlink or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

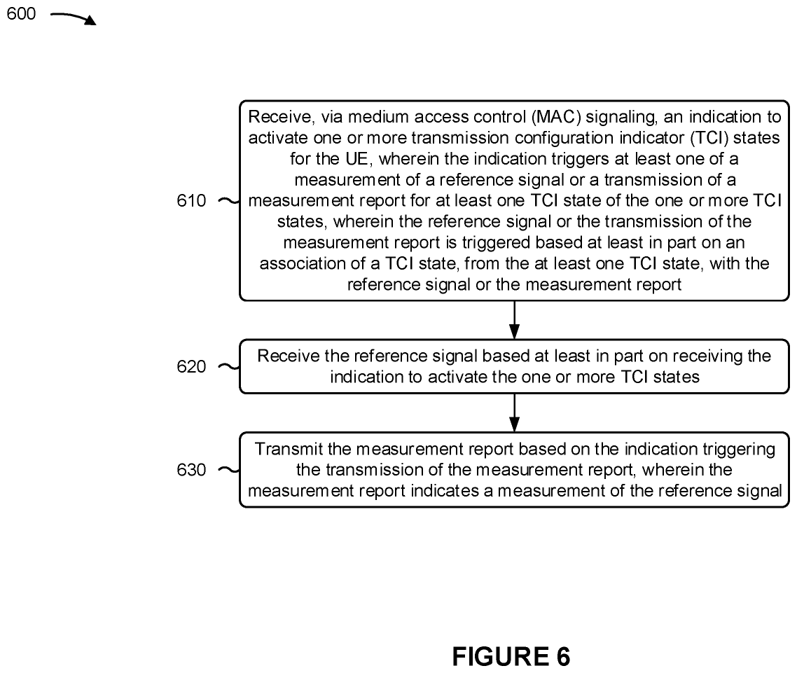

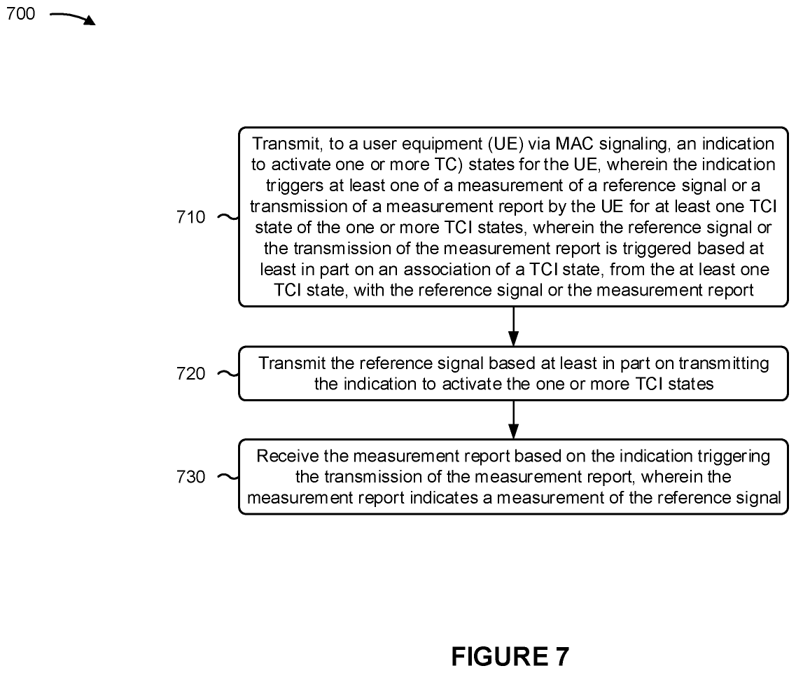

The controller/processor 240 of the base station 110, the controller/processor 280 of the UE 120, or any other component(s) of FIG. 2 may perform one or more techniques associated with MAC signaling triggering a TCI state update and a beam measurement or report, as described in more detail elsewhere herein. For example, the controller/processor 240 of the base station 110, the controller/processor 280 of the ULE 120, or any other component(s) of FIG. 2 may perform or direct operations of, for example, process 600 of FIG. 6, process 700 of FIG. 7, or other processes as described herein. The memory 242 and the memory 282 may store data and program codes for the base station 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the base station 110 or the UE 120, may cause the one or more processors, the UE 120, or the base station 110 to perform or direct operations of, for example, process 600 of FIG. 6, process 700 of FIG. 7, or other processes as described herein. In some examples, executing instructions may include running the instructions, converting the instructions, compiling the instructions, or interpreting the instructions, among other examples.

In some aspects, the UE 120 includes means for receiving, via MAC signaling, an indication to activate one or more TCI states for the UE 120, wherein the indication triggers at least one of a measurement of a reference signal or a transmission of a measurement report for at least one TCI state of the one or more TCI states, wherein the reference signal or the transmission of the measurement report is triggered based at least in part on an association of a TCI state, from the at least one TCI state, with the reference signal or the measurement report; means for receiving the reference signal based at least in part on receiving the indication to activate the one or more TCI states; or means for transmitting the measurement report based on the indication triggering the transmission of the measurement report, wherein the measurement report indicates a measurement of the reference signal. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for transmitting, to a UE via MAC signaling, an indication to activate one or more TCI states for the UE, wherein the indication triggers at least one of a measurement of a reference signal or a transmission of a measurement report by the UE for at least one TCI state of the one or more TCI states, wherein the reference signal or the transmission of the measurement report is triggered based at least in part on an association of a TCI state, from the at least one TCI state, with the reference signal or the measurement report; means for transmitting the reference signal based at least in part on transmitting the indication to activate the one or more TCI states; or means for receiving the measurement report based on the indication triggering the transmission of the measurement report, wherein the measurement report indicates a measurement of the reference signal. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

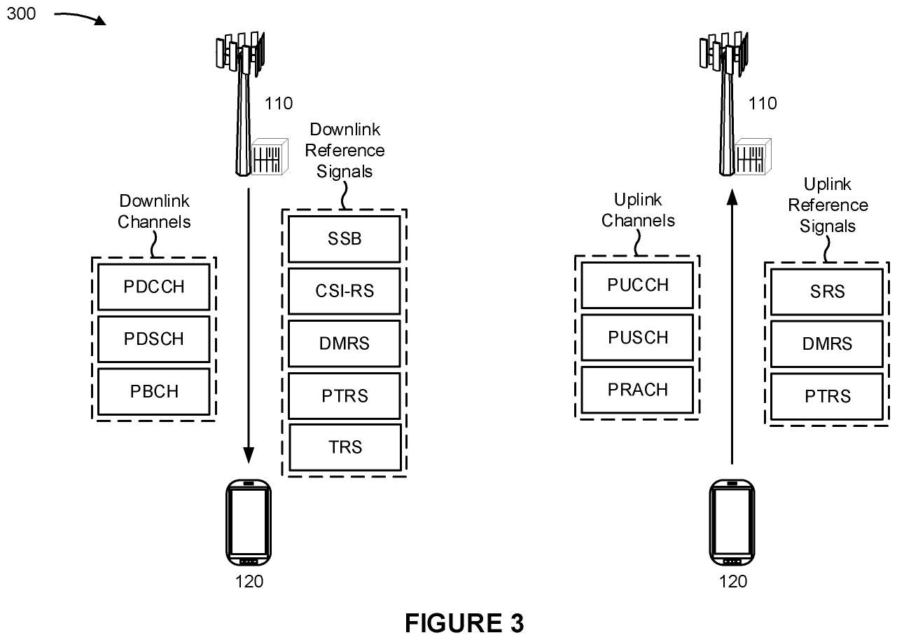

FIG. 3 is a diagram illustrating an example of physical channels and reference signals 300 in a wireless network, in accordance with the present disclosure. As shown in FIG. 3, downlink channels and downlink reference signals may carry information from a base station 110 to a UE 120, and uplink channels and uplink reference signals may carry information from a UE 120 to a base station 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some examples, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some examples, the UE 120 may transmit acknowledgement (ACK) or negative acknowledgement (NACK) feedback (for example, ACK/NACK feedback or ACK/NACK information) in UCI on the PUCCH or the PUSCH.

As further shown, a downlink reference signal may include an SSB, a channel state information (CSI) reference signal (CSI-RS), a DMRS, a positioning reference signal (PRS), a phase tracking reference signal (PTRS), or a tracking reference signal (TRS), among other examples. As also shown, an uplink reference signal may include a sounding reference signal (SRS), a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some examples, the base station 110 may transmit multiple SSBs on multiple corresponding beams, and the SSBs may be used for beam selection.

A CSI-RS may carry information used for downlink channel estimation (for example, downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least in part on the measurements, the UE 120 may perform channel estimation and may report channel estimation parameters to the base station 110 (for example, in a CSI report), such as a CQI, a precoding matrix indicator (PMI), a CSI-RS resource indicator (CRI), a layer indicator (LI), a rank indicator (RI), or an RSRP, among other examples. The base station 110 may use the CSI report to select transmission parameters for downlink communications to the UE 120, such as a quantity of transmission layers (for example, a rank), a precoding matrix (for example, a precoder), an MCS, or a refined downlink beam (for example, using a beam refinement procedure or a beam management procedure), among other examples.

A DMRS may carry information used to estimate a radio channel for demodulation of an associated physical channel (for example, PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (for example, rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (for example, on the PDSCH) and uplink communications (for example, on the PUSCH).

A TRS may be a downlink reference signal and may carry information used to assist in time domain and frequency domain tracking. The TRS may be used to track transmission path delay spread or Doppler spread. A TRS may be UE-specific. In some examples, a TRS may be transmitted in a TRS burst. A TRS burst may consist of four OFDM symbols in two consecutive slots. In some examples, a TRS may be associated with one or more CSI-RS configurations. For example, a TRS burst may use one or more CSI-RS resources.

A PRS may carry information used to enable timing or ranging measurements of the UE 120 based on signals transmitted by the base station 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (for example, a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (for example, a reference cell and one or more neighbor cells), and may report a reference signal time difference (RSTD) based on OTDOA measurements associated with the PRSs received from the multiple cells. In some examples, the base station 110 may then calculate a position of the UE 120 based on the RSTD measurements reported by the UE 120.

An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

In some cases, the UE 120 may be configured to measure one or more reference signals. For example, the UE 120 may receive a downlink reference signal and may measure a parameter (for example, a signal strength, a signal quality, an RSRP, or an RSRQ, among other examples) of the downlink reference signal. The UE 120 may be configured to transmit, to the base station 110, a measurement report indicating a measurement of the downlink reference signal. The base station 110 may use the measurement(s) indicated in the measurement report for beam management determinations, handover determinations, or other link management determinations.

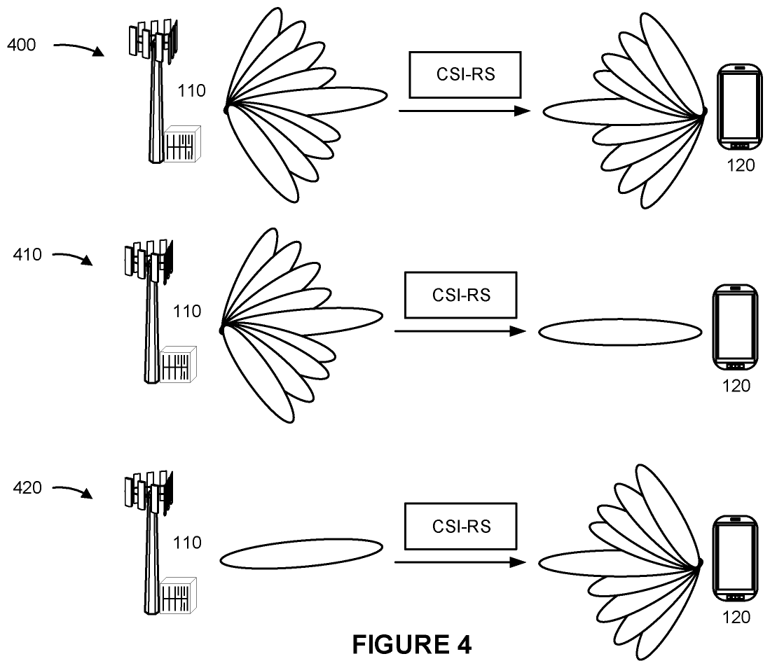

FIG. 4 is a diagram illustrating examples of CSI-RS beam management procedures 400, 410, and 420, in accordance with the present disclosure. As shown in FIG. 4, CSI-RS beam management procedures 400, 410, and 420 may be associated with a UE 120 in communication with a base station 110 in a wireless network (such as the wireless network 100). However, the devices shown in FIG. 4 are provided as examples, and the wireless network may support communication and beam management between other devices (for example, between a UE 120 and a base station 110 or TRP, between a mobile termination node and a control node, between an integrated access and backhaul (IAB) child node and an IAB parent node, or between a scheduled node and a scheduling node). In some examples, the UE 120 and the base station 110 may be in a connected state (for example, an RRC connected state).

As shown in FIG. 4, CSI-RS beam management procedure 400 may include a base station 110 and a UE 120 communicating to perform beam management using CSI-RSs. CSI-RS beam management procedure 400 depicts a first beam management procedure (for example, a P1 CSI-RS beam management). The first beam management procedure may be referred to as a beam selection procedure, an initial beam acquisition procedure, a beam sweeping procedure, a cell search procedure, or a beam search procedure, among other examples. As shown in FIG. 4 and the CSI-RS beam management procedure 400, CSI-RSs may be configured to be transmitted from the base station 110 to the UE 120. The CSI-RSs may be configured to be periodic (for example, using RRC signaling), semi-persistent (for example, using MAC-CE signaling), or aperiodic (for example, using DCI).

The first beam management procedure may include the base station 110 performing beam sweeping over multiple transmit (Tx) beams. The base station 110 may transmit a CSI-RS using each transmit beam for beam management. To enable the UE 120 to perform receive (Rx) beam sweeping, the base station 110 may use a transmit beam to transmit (for example, with repetitions) each CSI-RS at multiple times within the same reference signal (RS) resource set so that the UE 120 can sweep through receive beams in multiple transmission instances. For example, if the base station 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the base station 110, the UE 120 may perform beam sweeping through the receive beams of the UE 120. As a result, the first beam management procedure may enable the UE 120 to measure a CSI-RS on different transmit beams using different receive beams to support selection of base station 110 transmit beams/UE 120 receive beam(s) beam pair(s). The UE 120 may report the measurements to the base station 110 to enable the base station 110 to select one or more beam pair(s) for communication between the base station 110 and the UE 120 (for example, in a measurement report). While example 400 has been described in connection with CSI-RSs, the first beam management process may also use SSBs for beam management in a similar manner as described above.

As shown in FIG. 4, CSI-RS beam management procedure 410 may include a base station 110 and a UE 120 communicating to perform beam management using CSI-RSs. The CSI-RS beam management procedure 410 depicts a second beam management procedure (for example, a P2 CSI-RS beam management, also referred to herein as beam refinement for a transmitter). The second beam management procedure may be referred to as a beam refinement procedure, a base station beam refinement procedure, a TRP beam refinement procedure, or a transmit beam refinement procedure, among other examples. As shown in FIG. 4 and the CSI-RS beam management procedure 410, CSI-RSs may be configured to be transmitted from the base station 110 to the UE 120. The CSI-RSs may be configured to be aperiodic (for example, using DCI). The second beam management procedure may include the base station 110 performing beam sweeping over one or more transmit beams. The one or more transmit beams may be a subset of all transmit beams associated with the base station 110 (for example, determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (for example, the same) receive beam (for example, determined based at least in part on measurements performed in connection with the first beam management procedure). The second beam management procedure may enable the base station 110 to select a best transmit beam based at least in part on measurements of the CSI-RSs (for example, measured by the UE 120 using the single receive beam) reported by the UE 120 (for example, in a measurement report).

As shown in FIG. 4, CSI-RS beam management procedure 420 depicts a third beam management procedure (for example, a P3 CSI-RS beam management, also referred to herein as beam refinement for a receiver). The third beam management procedure may be referred to as a beam refinement procedure, a UE beam refinement procedure, or a receive beam refinement procedure, among other examples. As shown in FIG. 4 and the CSI-RS beam management procedure 420, one or more CSI-RSs may be configured to be transmitted from the base station 110 to the UE 120. The CSI-RSs may be configured to be aperiodic (for example, using DCI). The third beam management procedure may include the base station 110 transmitting the one or more CSI-RSs using a single transmit beam (for example, determined based at least in part on measurements reported by the UE 120 in connection with the first beam management procedure or the second beam management procedure). To enable the UE 120 to perform receive beam sweeping, the base station may use a transmit beam to transmit (for example, with repetitions) CSI-RS at multiple times within the same RS resource set so that UE 120 can sweep through one or more receive beams in multiple transmission instances. The one or more receive beams may be a subset of all receive beams associated with the UE 120 (for example, determined based at least in part on measurements performed in connection with the first beam management procedure or the second beam management procedure). The third beam management procedure may enable the base station 110 or the UE 120 to select a best receive beam based at least in part on reported measurements received from the UE 120 (for example, of the CSI-RS of the transmit beam using the one or more receive beams).

As described above, a measurement or associated reporting may be triggered by a message from the base station 110 (for example, a DCI or a MAC-CE). For example, the base station 110 may trigger the UE 120 to perform CSI-RS measurement and reporting, P1 CSI-RS beam management measurement and reporting, P2 CSI-RS beam management measurement and reporting, P3 CSI-RS beam management measurement and reporting, or TRS measurement and reporting, among other examples. As used herein, “triggering an RS” can refer to “triggering measurement of a resource configured for the RS” or to “triggering transmission of an RS.”

The UE 120 may transmit measurement reports using an uplink control channel (for example, the PUCCH) or an uplink shared channel (for example, the PUSCH). The measurement reports may be configured to be aperiodic, semi-persistent, or periodic. For example, the UE 120 may transmit aperiodic or semi-persistent measurement reports using the uplink shared channel (for example, the PUSCH). The UE 120 may transmit semi-persistent or periodic measurement reports using the uplink control channel (for example, the PUCCH). The UE 120 may identify resources to be used for transmitting the measurement based at least in part on a scheduling method of measurement reporting (for examples, periodic, semi-persistent, or periodic) or on the channel to be used to transmit the measurement report. For example, one or more transmission parameters (for example, a time domain resource allocation (TDRA), a frequency domain resource allocation (FDRA), an MCS, or a hybrid automatic repeat request (HARQ) process identifier, among other examples) for the measurement report may be configured in an RRC configuration. As used herein, “transmission parameter” may refer to a parameter to be used by a UE for a transmission of an uplink message. For example, a transmission parameter may include a TDRA, an FDRA, an MCS, a quantity of transmission layers (for example, a rank), or a precoding matrix (for example, a precoder), among other examples. For example, a CSI report configuration (for example, a CSI reportConfig) may indicate a channel (for example, the PUCCH or the PUSCH) associated with the CSI report configuration, a scheduling method associated with the CSI report configuration (for example, periodic, semi-persistent, or periodic), or one or more resources (for examples, CSI-RS resources) to be measured (for example, in a reportQuantity field), among other examples.

A measurement report can be configured as periodic (P), semi-persistent (SP), or aperiodic (AP). A periodic measurement report is transmitted periodically on a configured resource until de-configured. A semi-persistent measurement report, once activated by signaling (for example, dynamic signaling) is transmitted periodically on a configured resource until deactivated by signaling (for example, dynamic signaling). An aperiodic measurement report is transmitted after being triggered. A periodic measurement report can be associated with a periodic CSI-RS (P-CSI-RS). A semi-persistent report can be associated with a P-CSI-RS or a semi-persistent CSI-RS (SP-CSI-RS). An aperiodic report can be associated with a P-CSI-RS, an SP-CSI-RS, or an aperiodic CSI-RS (AP-CSI-RS). A periodic measurement report can be activated in RRC, or, using the techniques described herein, an indication to update a beam. A semi-persistent measurement report can be activated by a MAC-CE or DCI, depending on the channel. For example, a semi-persistent measurement report in the PUCCH can be activated by MAC-CE using a report configuration identifier, and a semi-persistent measurement report in the PUSCH can be activated by DCI (via a CSI report field and semi persistent CSI (SP-CSI) radio network temporary identifier (RNTI) scrambling) using a SP-CSI PUSCH trigger state identifier. An aperiodic measurement report can be activated in DCI, by a CSI report field and cell RNTI (C-RNTI) scrambling using an aperiodic CSI (AP-CSI) trigger state identifier. An aperiodic CSI report configuration associated with a periodic CSI-RS can be triggered by DCI and by a MAC-CE. For example, an AP-CSI trigger state sub-selection MAC-CE may indicate one or more active entries within an AP-CSI trigger state list.

In some cases, a base station may update a beam to be used by a UE. For example, the base station may transmit, to the UE, an indication to switch a beam used by the UE to a new beam. As used herein, a message that indicates that the UE is to switch a beam used by the UE may be referred to as a “beam switch indication,” a “beam indication,” or a “transmission configuration indicator (TCI) state update,” among other examples. For example, the base station may indicate a new beam to be used by the UE using a DCI message or a MAC-CE message, among other examples. In some examples, the base station may indicate a beam switch or a beam update to the UE using DCI that uses a downlink DCI format. “Downlink DCI format” may refer to a DCI format that is associated with scheduling or indicating information associated with downlink messages (for example, as defined, or otherwise fixed, by a wireless communication standard, such as the 3GPP). Examples of downlink DCI formats may include a DCI format 1_0, a DCI format 1_1, or a DCI format 1_2, among other examples (for example, as defined, or otherwise fixed, by a wireless communication standard, such as the 3GPP).

As described above, beam measurement or associated reporting may be triggered by a base station by transmitting a message (for example, DCI or MAC-CE) to the UE. For example, the base station may transmit a DCI message or a MAC-CE message triggering beam measurement or a measurement report. For example, for an aperiodic measurement report or a semi-persistent measurement report (to be transmitted on an uplink shared channel), the base station may transmit DCI (using an uplink DCI format) to trigger the measurement report.

In some cases, it may be beneficial for a UE to measure a beam after a beam switch or a beam update. For example, the UE may measure or report measurements of a new beam (for example, after receiving a beam switch indication or a beam update) to the base station. The beam measurement and associated reporting may enable the base station to make improved beam management determinations. However, to trigger a beam switch or a beam update and to trigger the UE to transmit a measurement report, the base station may have to transmit multiple messages to the UE. For example, the base station may transmit a first message to trigger the beam switch or the beam update. The base station may transmit a second message to trigger the beam measurement or the measurement report. This may consume resources associated with transmitting the multiple messages to trigger a beam switch and to trigger the beam measurement or the measurement report.

Various aspects relate generally to MAC signaling (for example, MAC-CE signaling) triggering a TCI state update (or a beam update) and a beam measurement or report. Some aspects more specifically relate to a MAC-CE message that activates one or more TCI states, triggering a measurement of a reference signal or a transmission of a measurement report (for example, by a UE) for at least one TCI state of the one or more TCI states. For example, a MAC-CE message may indicate one or more TCI states to be activated by the UE. At least one TCI state, of the one or more TCI states, may be associated with, or linked with, one or more trigger states, one or more reporting configurations, or one or more beam measurement procedures to be performed by the UE. Therefore, when the UE receives the MAC-CE message that activates the one or more TCI states, the UE may also be triggered to perform measurements or to transmit a measurement report.

In some aspects, a configuration or determination of an association between TCI states and reference signal resource sets or measurement report configurations may be provided. In some aspects, the MAC-CE message that activates the one or more TCI states and that triggers the UE to perform measurements or to transmit a measurement report may include an indication of the association between TCI states and reference signal resource sets or measurement report configurations. In some aspects, the association between TCI states and reference signal resource sets or measurement report configurations may be based at least in part on signaling (for example, the MAC-CE message or another message, such as an RRC message) that configures the association. In some other aspects, the association between TCI states and reference signal resource sets or measurement report configurations may be based at least in part on one or more rules.

Particular aspects of the subject matter described in this disclosure can be implemented to realize one or more of the following potential advantages. In some examples, the described techniques can be used to activate one or more TCI states and trigger the UE to perform measurements or to transmit a measurement report associated with at least one TCI state in the same message (for example, in a single message). This may conserve resources that would have otherwise been used to transmit multiple messages to activate the one or more TCI states and to trigger the beam measurement or the measurement report. In some examples, the described techniques can be used to activate one or more TCI states, to indicate an association between TCI states and reference signal resource sets or measurement report configurations, and trigger the UE to perform measurements or to transmit a measurement report associated with at least one TCI state in the same message (for example, in a single message). This may conserve resources that would have otherwise been used to transmit multiple messages to configure the association between TCI states and reference signal resource sets or measurement report configurations, to activate the one or more TCI states, and to trigger the beam measurement or the measurement report. In some examples, the described techniques can be used to activate multiple TCI states and to trigger the UE to perform measurements or to transmit a measurement report associated with one or more (or all) of the multiple TCI states. This provides additional flexibility for the base station by enabling the base station to activate multiple TCI states and to trigger one or more beam measurements (by the UE) or one or more measurement reports in the same message (for example, in a single message).

In some examples, the described techniques can be used to reduce a latency associated with activating a TCI state. For example, if a TCI state is activated using a message, the UE may receive the message (for example, a MAC-CE) activating the TCI state, may receive an SSB that is associated with the TCI state (for example, to receive some information associated with the TCI state), and may activate the TCI state an amount of time after receiving the SSB. However, SSBs are transmitted periodically and a time to a next SSB (after receiving the message activating the TCI state) may be significant. In some examples, the described techniques can be used to activate a TCI state and to trigger a measurement of a reference signal by the UE in the same message. A timing offset between the message and a transmission of the reference signal may be less than a time between the message an a next SSB associated with the TCI state. Therefore, the UE may be enabled to measure the reference signal (for example, to receive some information associated with the TCI state) and may activate the TCI state sooner than if the UE waited to receive the next SSB associated with the TCI state. Additionally, in some examples, the described techniques can be used to support a configuration of multiple actions (for example, multiple beam measurements or measurement reports) using a single triggering message, which improves flexibility of concurrent triggering of beam switch and measurement or measurement reporting.

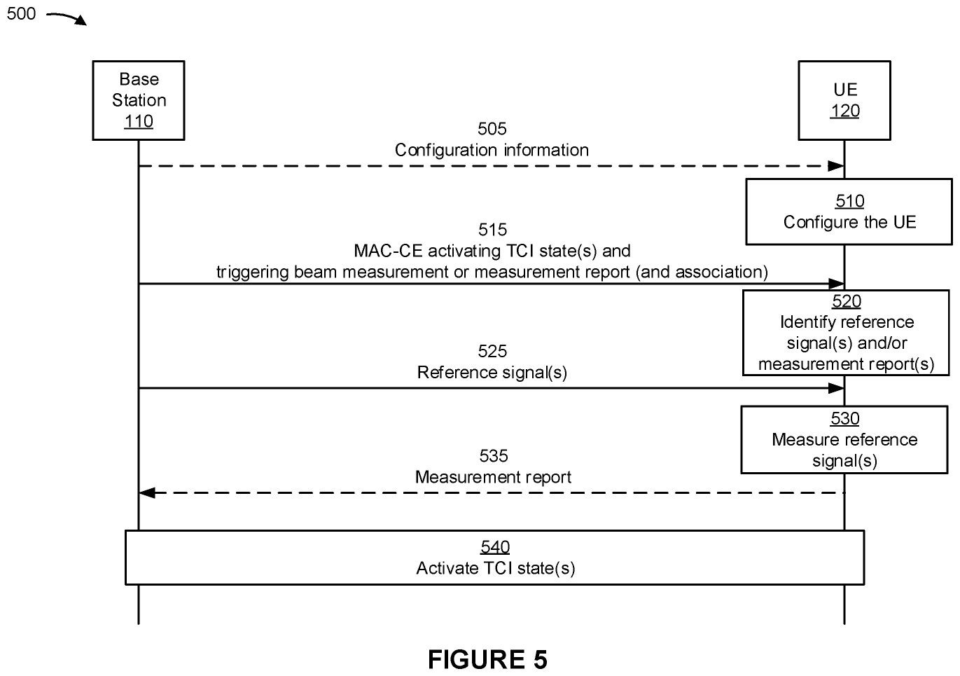

FIG. 5 is a diagram illustrating an example associated with MAC signaling triggering a TCI state update or activation and a beam measurement or report, in accordance with the present disclosure. As shown in FIG. 5, a base station 110 and a UE 120 may communicate with one another in a wireless network, such as the wireless network 100. FIG. 5 depicts an example associated with configuring an association between an indication to activate a TCI state and at least one of a measurement of a reference signal or transmission of a measurement report (for example, a CSI measurement report). For example, a MAC-CE may trigger the UE 120 to measure a resource configured for the reference signal or may trigger the UE 120 to transmit a measurement report associated with the measurement of the reference signal. The measurement report may be an aperiodic measurement report, a semi-persistent measurement report, or a periodic measurement report. The measurement report may be associated with an uplink control channel (for example, the measurement report may be configured to be transmitted on the PUCCH). In some other aspects, the measurement report may be associated with an uplink shared channel (for example, the measurement report may be configured to be transmitted on the PUSCH). In some aspects, the association between the indication and the reference signal or the measurement report is configured (for example, via signaling from the base station 110, such as the MAC-CE message that activates one or more TCI states). In some other aspects, the association is based at least in part on a rule.

In a first operation 505, the base station 110 may transmit, and the UE 120 may receive, configuration information. In some aspects, the UE 120 may receive configuration information from another device (for example, from another base station or another UE). In some aspects, the UE 120 may receive the configuration information via RRC signaling or MAC signaling (for example, MAC control elements). In some aspects, the configuration information may be updated by MAC signaling, or by DCI. In some aspects, the configuration information may include an indication of one or more configuration parameters (for example, already known to the UE 120) for selection by the UE 120 or explicit configuration information for the UE 120 to use to configure the UE 120. The configuration information may indicate an association (for example, a linkage) between a beam (such as a TCI state) and one or more reference signals for measurement, as described in more detail elsewhere herein. Additionally or alternatively, the configuration information may indicate an association (for example, a linkage) between a beam (such as a TCI state) and one or more measurement reports, as described in more detail elsewhere herein. Thus, a signaling-based approach can be used to indicate the association between TCI states and reference signal resources (or resource sets) or between TCI states and measurement report configurations. In some aspects, rather than indicating the association between TCI states and reference signal resources (or resource sets) or between TCI states and measurement report configurations via the configuration information, the association(s) may be indicated by a MAC-CE message that activates the TCI state(s), as explained in more detail elsewhere herein. In some other aspects, a rule-based approach may be used where the association between TCI states and reference signal resources (or resource sets) or between TCI states and measurement report configurations is not signaled between the UE 120 and the base station 110.

In some aspects, the configuration information may indicate that one or more features are enabled for the UE 120 associated with measurement procedures or measurement reports that are triggered by TCI state activation messages. For example, the configuration information may indicate that measurement procedures or measurement reports may be triggered by a message (for example, a MAC-CE) that includes an activation of one or more TCI states.

In some aspects, the configuration information may indicate an action. For example, the configuration information may indicate that the one or more features are enabled for a P3 CSI-RS beam management (for example, beam refinement for a receiver), a TRS, CSI measurement or reporting, or P2 CSI-RS beam management (for example, beam refinement for a transmitter), among other examples. As another example, the configuration information may indicate whether the action is periodic, aperiodic, or semi-persistent. For example, the configuration information may indicate whether a P3 or P2 CSI-RS beam management is performed periodically (for example, using a configured resource associated with a periodicity), aperiodically (for example, when triggered), or semi-persistently (for example, using a configured resource that is activated or deactivated by dynamic signaling). As another example, the configuration information may indicate whether a TRS measurement is performed periodically (for example, using a configured resource associated with a periodicity), aperiodically (for example, when triggered), or semi-persistently (for example, using a configured resource that is activated or deactivated by dynamic signaling). In some other aspects, the action may be indicated by a message (for example, a MAC-CE), that includes an activation of one or more TCI states, and that triggers the action (for example, that triggers a beam measurement or a transmission of a measurement report).

In some aspects, the configuration information may indicate an association between a beam (or a TCI state) and a reference signal or a measurement report. For example, an association between an indicated TCI state for a beam, and a reference signal for measurement or a measurement report, may be configured by signaling from the base station 110 (such as RRC signaling (which can be updated via MAC signaling) or dynamic signaling such as DCI). In some other aspects, the association between an activated TCI state and a reference signal for measurement or a measurement report may be indicated via a MAC-CE message that activates the TCI state. In some aspects, the configuration information may be transmitted via RRC signaling or MAC signaling, and may associate a TCI state and trigger state, or a TCI state and a CSI-RS resource. If the configuration information is transmitted via MAC signaling, the UE 120 may apply the association after an activation period, which may be measured after transmitting an acknowledgment associated with the MAC signaling.

A beam may be associated with a TCI state. A TCI state may indicate a directionality or a characteristic of the beam, such as one or more quasi co-location (QCL) properties of the downlink beam. A QCL property may include, for example, a Doppler shift, a Doppler spread, an average delay, a delay spread, or spatial receive parameters, among other examples. A TCI state may be associated with one downlink reference signal set (for example, an SSB and an aperiodic, periodic, or semi-persistent CSI-RS) for different QCL types (for example, QCL types for different combinations of Doppler shift, Doppler spread, average delay, delay spread, or spatial receive parameters, among other examples).

In some aspects, the association may be between a TCI state and a CSI measurement without transmission of a measurement report. For example, a report quantity of a CSI report configuration of the CSI measurement may be set to “none”, which enables the UE 120 to perform a CSI measurement using the TCI state without transmitting a measurement report, thereby conserving signaling resources.

In some aspects, the association may be between a TCI state and a trigger state (such as a codepoint of a trigger state or a trigger state identifier of a trigger state). In such examples, the configuration information may be provided via a TCI configuration information element (IE), that be included in an RRC configuration of the TCI state. A TCI state (or beam) may be configured as associated with a trigger state (such as associated with a codepoint of the trigger state or a trigger state identifier of the trigger state). A trigger state may be associated with one or more CSI report configurations. For example, a trigger state may be associated with multiple CSI report configurations. Each CSI report configuration may include a report resource field, a CSI-RS resource configuration (including a CSI-RS resource list), and a report quantity. Thus, when the UE 120 receives an indication indicating a particular TCI state, the indication can also activate each CSI report configuration that is configured as associated with the particular TCI state. In some aspects, the configuration information may clarify which list the TCI state is associated with, from an SP-CSI report PUSCH list or an AP-CSI report list, among other examples. Configuring the association between the TCI state and the trigger state may enable the reuse of a trigger state list parameter and a trigger state identifier, such that a TCI state can be associated with multiple CSI reporting configurations without defining a new information element or list.

In some aspects, the association may be between a TCI state and a CSI report configuration. In such examples, the configuration information may be provided via an RRC IE outside of the TCI state. If the association is between a TCI state and a CSI report configuration, the TCI state can be associated with any CSI report configuration identifier, such as an SP-CSI report configuration on a PUCCH.

In some aspects, the UE 120 may transmit an acknowledgment associated with the configuration information (not shown). The acknowledgment may indicate whether or not the configuration information was received. In some aspects, the UE 120 may apply the configuration information after an activation period. In some aspects, the activation period may be configured (such as via RRC configuration), may be indicated by the configuration information, or may be defined, such as in a wireless communication standard.

In a second operation 510, the UE 120 may configure the UE 120 for communicating with the base station 110. In some aspects, the UE 120 may configure the UE 120 based at least in part on the configuration information. In some aspects, the UE 120 may be configured to perform one or more operations described herein.

In a third operation 515, the base station 110 may transmit, and the UE 120 may receive, via MAC signaling (for example, via one or more MAC-CEs) an indication to activate one or more TCI states for the UE 120. A MAC-CE message that includes an indication to activate one or more TCI states may be referred to herein as a “TCI state activation MAC-CE” or a “beam activation MAC-CE.” The TCI state activation MAC-CE may activate one or more TCI states. For example, because a payload capacity of a MAC-CE (an amount, or a size, of information that can be carried by the MAC-CE) is greater than the payload capacity of other downlink messages (such as downlink messages transmitted on the PDCCH or DCI message), a TCI state activation MAC-CE may activate multiple TCI states in the same message (for example, whereas a DCI message may only activate a single TCI state is the DCI message).

In some aspects, the TCI state activation MAC-CE may trigger a measurement of a reference signal or a transmission of a measurement report for at least one TCI state indicated by the TCI state activation MAC-CE. In some aspects, the TCI state activation MAC-CE may trigger a measurement of a reference signal or a transmission of a measurement report for a single TCI state indicated by the TCI state activation MAC-CE. In some other aspects, the TCI state activation MAC-CE may trigger a measurement of a reference signal or a transmission of a measurement report for multiple TCI states (or all TCI states) indicated by the TCI state activation MAC-CE.

In some aspects, the TCI state activation MAC-CE may trigger a measurement of a reference signal or a transmission of a measurement report for each TCI state indicated by the TCI state activation MAC-CE (so long as the TCI state(s) have been associated with a reference signal or a measurement report configuration, such as by the configuration information or by the TCI state activation MAC-CE). In some other aspects, the TCI state activation MAC-CE may trigger a measurement of a reference signal or a transmission of a measurement report for each TCI state included in a subset of the TCI states indicated by the TCI state activation MAC-CE. For example, a rule may indicate which TCI state(s), among the TCI states indicated by the TCI state activation MAC-CE, are to be associated with a triggered beam measurement or measurement report. For example, the rule may indicate that the UE 120 is to identify the TCI state(s), among the TCI states indicated by the TCI state activation MAC-CE, are to be associated with a triggered beam measurement or measurement report based at least in part on identifiers (TCI state identifiers) associated with the TCI states indicated by the TCI state activation MAC-CE. For example, the rule may indicate that a TCI state associated with a lowest value for a TCI state identifier, among values of TCI state identifiers for the TCI states indicated by the TCI state activation MAC-CE, is to be associated with a triggered beam measurement or measurement report.

For example, the TCI state activation MAC-CE may include an indication of multiple TCI states that are to be activated for the UE 120. The TCI state activation MAC-CE may trigger a measurement of a reference signal or a transmission of a measurement report for each TCI state of the multiple TCI states. In some other aspects, the TCI state activation MAC-CE may trigger a measurement of a reference signal or a transmission of a measurement report for each TCI state of a subset of TCI states of the multiple TCI states.

In some aspects, a TCI state indicated by the TCI state activation MAC-CE may be associated with a unified TCI framework. For example, in a unified TCI framework, a single TCI state may be associated with multiple reference signals or multiple channels. For example, multiple reference signals (or multiple reference signal types) may be associated with a single TCI state. For example, CSI-RS resource(s) that are associated with CSI and CSI-RS resource(s) that are associated with beam management may be associated with the same TCI state. Similarly, an uplink reference signal, such as an SRS, may be associated with a TCI state that is also associated with PUSCH messages or PUCCH messages. In some aspects, a TCI state indicated by the TCI state activation MAC-CE may indicate a spatial filter to be used for reception operations by the UE 120 on the PDSCH and for reception operations by the UE 120 on the PDCCH. For example, a TCI state may indicate a spatial filter for UE-dedicated reception on the PDSCH and for UE-dedicated reception on all (or a subset of) control resource sets (CORESETs) in a carrier or component carrier (CC).

In some aspects, a TCI state indicated by the TCI state activation MAC-CE may indicate a spatial filter to be used for reception operations by the UE 120 for one or more downlink reference signals. For example, a single TCI state indicated by the TCI state activation MAC-CE may indicate a spatial filter to be used for reception operations by the UE 120 for CSI-RS(s) associated with beam management (for example, associated with a beam management procedure as described in connection with FIG. 4) and to be used for reception operations by the UE 120 for CSI-RS(s) associated with CSI acquisition. In some aspects, the TCI state may be associated with aperiodic CSI-RS resources for CSI-RS(s) associated with beam management. For CSI-RS(s) associated with beam management, the TCI state may be associated with aperiodic CSI-RS resources or CSI-RS resources for a P3 beam management procedure. In some aspects, a TCI state that is applied to, or associated with a CSI-RS resource set may be applied to all CSI-RS resources included in the CSI-RS resource set.

In some aspects, one or more TCI states indicated by the TCI state activation MAC-CE may be associated with, or configured with, a non-serving cell. “Non-serving cell” may refer to a cell that is not associated with an active connection with the UE 120 (for example, that is not associated with an active or connected RRC state) or may refer to a cell that is not the serving cell. “Serving cell” may refer to a cell that is associated with an active connection with the UE 120 or a cell from which the UE 120 receives control information, such as RRC configuration information. In some aspects, the TCI state activation MAC-CE may indicate one TCI state associated with a non-serving cell. The TCI state may be associated with, or applied to, channel(s) or reference signal(s) associated with the non-serving cell. In some aspects, the TCI state activation MAC-CE may indicate multiple TCI states associated with the same non-serving cell. In some aspects, additional signaling (such as DCI signaling) from the base station 110 to the UE 120 may select one or more TCI states for the non-serving cell from the multiple TCI states indicated by the TCI state activation MAC-CE (for example, for a channel associated with the non-serving cell). In other words, the TCI state activation MAC-CE may indicate TCI states for a serving cell and for one or more non-serving cells. In some aspects, an application delay or a beam activation time for a TCI state associated with the serving cell and an application delay or a beam activation time for a TCI state associated with a non-serving cell may be different (for example, may be based at least in part on different rules). Rules associated with determining the application delay or the beam activation time for a TCI state are described in more detail elsewhere herein.

In some aspects, a TCI state indicated by the TCI state activation MAC-CE may be a joint uplink and downlink TCI state. A TCI state that indicates properties for a common beam may be referred to as a joint downlink and uplink TCI state. A beam may be “common” when the beam is used by the UE 120 to transmit data or control information on the uplink as well as used by the UE 120 to receive data or control information on the downlink. In some aspects, the TCI state activation MAC-CE may indicate a pair of TCI states that includes an uplink TCI state (for example, a TCI state to be used for uplink communications) and a downlink TCI state (for example, a TCI state to be used for downlink communications), where the uplink TCI state and the downlink TCI state (for example, separate downlink and uplink TCI states) are associated with the same cell.

In some aspects, the TCI state activation MAC-CE may include an indication of which (if any) TCI states, that are indicated by the TCI state activation MAC-CE, are to be associated with a triggered beam measurement or measurement report. For example, the TCI state activation MAC-CE may include a bitmap that indicates, for each TCI state indicated by the TCI state activation MAC-CE, whether the TCI state is associated with a triggered beam measurement or measurement report. In this way, the TCI state activation MAC-CE may activate multiple TCI states. Additionally, this provides flexibility for the base station 110 to trigger beam measurements or measurement reports associated with multiple TCI states, or different TCI states, using a single message (for example, the TCI state activation MAC-CE). For example, the base station 110 may trigger the UE 120 to perform multiple measurement procedures or the transmission of multiple measurement reports using a single TCI state activation MAC-CE.

In some aspects, a TCI state may be activated (by the UE 120 or the base station 110) an amount of time after a TCI state activation MAC-CE is transmitted. The amount of time may be referred to as an “activation delay” or a “beam application time.” In some aspects, the amount of time may be determined (by the UE 120 or the base station 110) based at least in part on a rule (for example, that is defined, or otherwise fixed, by a wireless communication standard). The amount of time may be calculated differently depending on whether a TCI state is known by the UE 120. A TCI state is “known” by the UE 120 if a reference signal resource set (for beam reporting or measurement) associated with the TCI state has been received by the UE within 1280 milliseconds of receiving the TCI state activation MAC-CE (and if a signal-to-noise ratio (SNR) of the received reference signal satisfies a threshold). If a TCI state is known by the UE 120, then the beam application time may be calculated based at least in part on an amount of time equal to T_{HARQ}+3Nₛₗₒₜ^{subframe,u}+TOₖ (T_{first-SSB}+T_{SSB,proc}), where T_{HARQ} is an amount of time between receiving the TCI state activation MAC-CE and transmitting ACK/NACK feedback associated with the TCI state activation MAC-CE, 3Nₛₗₒₜ^{subframe,u} is an amount of time (for example, a delay) that is defined, or otherwise fixed by a wireless communication standard (such as Technical Specification 38.214 promulgated by the 3GPP), TOₖ is set to 0 (if the TCI state to be activated is included in a list of activated TCI states (for example, for the PDSCH) or is set to 1 (if the TCI state to be activated is not included in a list of activated TCI states), T_{first-SSB} is an amount of time from a transmission of the ACK/NACK feedback associated with the TCI state activation MAC-CE to a transmission of an SSB that is associated with the TCI state to be activated, and T_{SSB,proc} is an amount of time associated with the UE 120 processing the SSB (for example, that may be a fixed value for the UE 120, such as 2 milliseconds). The UE 120 may maintain a list of activated TCI states for the PDSCH. For example, each time the base station 110 activates a TCI state, the UE 120 may add the TCI state to a set of activated TCI states for the PDSCH. If the base station 110 indicates that a TCI state is deactivated, then the UE 120 may remove the TCI state from the set of activated TCI states for the PDSCH.

Therefore, as described above, the beam application time for a TCI state that is not included in a set of activate TCI states (or a list of activated TCI states) for the PDSCH may be dependent on a transmission schedule of the SSB associated with the TCI state to be activated. For example, SSBs may be transmitted periodically by the base station 110, such as every 20 milliseconds (or every 160 slots), among other examples. Therefore, if the TCI state activation MAC-CE is transmitted shortly after an SSB transmission, then the T_{first-SSB} may be a significant amount of time (for example, close to 20 milliseconds), resulting in a significant delay before the TCI state can be activated by the UE 120 and the base station 110. The UE 120 may need to receive the SSB associated with the TCI state before activating the TCI state because the UE 120 may obtain beam information (for example, QCL information, measurement information, time tracking information, or frequency tracking information) associated with the TCI state based at least in part on receiving or measuring the SSB.

As described above, the TCI state activation MAC-CE may trigger the UE 120 to measure a reference signal, such as a CSI-RS or a TRS, among other examples. In some aspects, the reference signal may be transmitted by the base station 110 (as described in more detail below in connection with the fifth operation 525) after a scheduling offset associated with the reference signal. The scheduling offset may be an amount of time relative receiving the indication to activate the one or more TCI states (relative to receiving the TCI state activation MAC-CE). For example, the scheduling offset for an aperiodic TRS may be 336 symbols (or 24 slots) from the reception of the TCI state activation MAC-CE. Therefore, the reference signal may be transmitted by the base station 110 a fixed (or a predictable) amount of time from the transmission of the TCI state activation MAC-CE. In some cases, the amount of time associated with the scheduling offset may be less than an amount of time associated with the T_{first-SSB} associated with the TCI state. The UE 120 may receive the reference signal and may perform one or more measurements (for example, that are triggered by the TCI state activation MAC-CE). The UE 120 may obtain beam information (for example, measurement information, time tracking information, or frequency tracking information) based at least in part on receiving and measuring the reference signal. Therefore, as described in more detail elsewhere herein, the UE 120 may activate the TCI state faster than if the UE 120 were to wait to receive the next SSB associated with the TCI state (for example, where the scheduling offset associated with the reference signal is less than an amount of time until the next SSB associated with the TCI state is scheduled to be transmitted by the base station 110).

In some aspects, the TCI state activation MAC-CE may indicate an association between a TCI state and a reference signal (for example, a reference signal resource or resource set) or a measurement report (for example, a measurement report configuration). For example, the association between TCI states and reference signals or measurement reports may be indicated by the TCI state activation MAC-CE. The association may be indicated or defined in a similar manner as described in connection with the configuration information. Therefore, rather than requiring the association(s) to be configured (for example, by an RRC configuration prior to a transmission of the beam switch or TCI state activation), the base station 110 may indicate the association(s) via the TCI state activation MAC-CE. For example, because a MAC-CE may have larger payload capacity (for example, compared to a DCI message), the additional information for indicating the association(s) may be included in the TCI state activation MAC-CE. This provides the base station 110 additional flexibility in configuring the associations between TCI states and reference signals or measurement reports. Additionally, this conserves resources that would have otherwise been used to communicate the association(s) via configuration information (such as via an RRC message).

In a fourth operation 520, the UE 120 may identify one or more reference signals or one or more measurement reports based at least in part on the association provided in the configuration information or in the TCI state activation MAC-CE. For example, the UE 120 may use the association, defined by the configuration information or by information included in the TCI state activation MAC-CE, to identify a reference signal (for example, a configuration associated with a reference signal or a resource associated with a reference signal) or a measurement report (for example, a configuration associated with a measurement report) corresponding to one or more TCI states identified by the TCI state activation MAC-CE.

In some other aspects, the association between TCI states and reference signals or measurement report configurations may be defined by a rule. For example, the UE 120 may be preconfigured with the rule. As another example, the rule may be provided in the configuration information. As another example, the rule may be specified, defined, or otherwise fixed in a wireless communication specification, such as one promulgated by the 3GPP. As yet another example, the UE 120 may be hardcoded with the rule. In some aspects, the base station 110 may transmit, and the UE 120 may receive, signaling activating the rule. For example, one or more rules may be RRC configured and the base station 110 may activate one or more of the RRC configured rules.

In some aspects, the rule may indicate the reference signal (for example, a configuration associated with a reference signal or a resource associated with a reference signal) or the measurement report based at least in part on a source reference signal of a beam used by the UE 120. “Source reference signal” may refer to a reference signal that is used to provide QCL information for a given TCI state. For example, the reference signal triggered by the TCI state activation MAC-CE may match a reference signal type of a source reference signal associated with a TCI state. A reference signal type may include TRS, or CSI-RS, among other examples. In some aspects, the TCI state activation MAC-CE may trigger a periodic TRS (P-TRS). For example, the source reference signal of the TCI state may be a P-TRS. In some aspects, the TCI state activation MAC-CE may trigger an aperiodic TRS (AP-TRS). For example, the source reference signal of the TCI state may be a P-TRS associated with the AP-TRS (for example, associated by configuration or semi-static signaling). In some aspects, the TCI state activation MAC-CE may trigger a CSI-RS. For example, if a feature associated with a CSI report is activated, then a CSI-RS resource set that includes a source reference signal of the TCI state may be triggered. In such examples, a CSI report configuration associated with a non-zero power (NZP) CSI-RS resource set list that includes the triggered CSI-RS resource set may be activated. For example, the TCI state activation MAC-CE may trigger a transmission of a measurement report associated with a measurement report configuration having a reference signal resource set to which the source reference signal belongs. An NZP CSI-RS resource may be a CSI-RS resource configured for reference signal transmission (as opposed to a zero-power CSI-RS resource in which no reference signal may be transmitted). In some aspects, the NZP CSI-RS resource set list may contain a single CSI-RS resource set. In some aspects, the NZP CSI-RS resource set list may contain multiple CSI-RS resource sets, each including the triggered CSI-RS resource set. In some aspects, the NZP CSI-RS resource set list may contain multiple CSI-RS resource sets and all of the multiple CSI-RS resource sets may use a TCI state indicated by the TCI state activation MAC-CE.

In some aspects, the rule may be based at least in part on an action associated with the measurement report or the reference signal (for example, P2 measurement or reporting, P3 measurement or reporting, or TRS measurement or reporting). For example, if a feature associated with P3 CSI-RS beam management (for example, beam refinement for a receiver) is activated, then a CSI-RS resource set with repetition activated, including a source reference signal of the indication, may be triggered. If a feature associated with P2 CSI-RS beam management is activated, then a CSI-RS resource set with repetition deactivated, including a source reference signal of the indication, may be triggered.

In some aspects, the rule may indicate the reference signal or the measurement report based at least in part on a TCI state to be activated by the TCI state activation MAC-CE. For example, a reference signal resource may be configured as associated with the reference signal. If a TCI state has multiple source reference signals for different QCL types, then the UE 120 may select a source reference signal of a particular QCL type to determine the reference signal triggered by the TCI state activation MAC-CE. For example, for an action associated with measuring a TRS, the UE 120 may select a source reference signal of the TCI state associated with QCL Type A (for example, including Doppler shift, Doppler spread, average delay, and delay spread QCL parameters). For an action associated with P2 CSI-RS beam management or P3 CSI-RS beam management, the UE 120 may select a source reference signal of the TCI state associated with QCL Type D (for example, including a spatial receive parameter QCL parameter).

For an action associated with measuring an AP-TRS, a TRS resource using the identified TCI state may be activated by the TCI state activation MAC-CE. For an action associated with measuring a CSI-RS or transmitting a CSI report, a CSI-RS resource set using the indicated TCI state may be activated by the TCI state activation MAC-CE. In such examples, a CSI report configuration associated with an NZP CSI-RS resource set list that includes the activated CSI-RS resource set may be activated. For example, the TCI state activation MAC-CE may trigger a measurement report associated with a measurement report configuration having a reference signal resource set to which the source reference signal belongs. In some aspects, the NZP CSI-RS resource set list must contain a single CSI-RS resource set. In some aspects, the NZP CSI-RS resource set list may contain multiple CSI-RS resource sets, each including the triggered CSI-RS resource set. In some aspects, the NZP CSI-RS resource set list may contain multiple CSI-RS resource sets and all of the multiple CSI-RS resource sets may use the TCI state indicated by the indication

In some aspects, the rule may be based at least in part on an action associated with the measurement report or the reference signal (for example, P2 CSI-RS beam management, P3 CSI-RS beam management, TRS measurement or reporting). For example, if a feature associated with P3 CSI-RS beam management (for example, beam refinement for a receiver) is activated by the TCI state activation MAC-CE, then a CSI-RS resource set with repetition activated, and all CSI-RS resources using an indicated TCI state, may be triggered by the TCI state activation MAC-CE. If a feature associated with P2 CSI-RS beam management is activated by the TCI state activation MAC-CE, then a CSI-RS resource set with repetition deactivated, and all resources using an indicated TCI state, may be triggered TCI state activation MAC-CE. In such examples, a beam management report configuration associated with an NZP CSI-RS set that includes the triggered CSI-RS resource set may be activated by the TCI state activation MAC-CE. In some aspects, the NZP CSI-RS resource set list may contain only the triggered CSI-RS resource set. In some aspects, the NZP CSI-RS resource set list may contain multiple CSI-RS resource sets the triggered CSI-RS resource set. In some aspects, the NZP CSI-RS resource set list may contain multiple CSI-RS resource sets and all of the multiple CSI-RS resource sets may use an TCI state indicated by the TCI state activation MAC-CE.

In some aspects, the association between a TCI state and a resource set may be unique (for example, a TCI state may be configured as associated with a single resource set, or the rule may indicate that a TCI state is associated with a single resource set). In some other aspects, the association between a TCI state and a resource set may be based at least in part on a prioritization rule. For example, the UE 120 may select among multiple candidate resource sets, such as based at least in part on the lowest resource set identifier of multiple candidate resource sets.

In some aspects, a reference signal triggered by the TCI state activation MAC-CE may be a pre-defined CSI-RS resource set list with floating TCI state. For example, a CSI-RS resource set list may be defined that includes one or more CSI-RS resource sets that are configured to be triggered by the TCI state activation MAC-CE. Each CSI-RS resource set may define one or more reference signal resources. The TCI state is referred to as a floating TCI state because the CSI-RS resource set has an undefined TCI state. After receiving the indication, an indicated TCI state may be applied to the CSI-RS resource set list, and reference signals on CSI-RS resources of the CSI-RS resource set list may be triggered by the TCI state activation MAC-CE. The CSI-RS resource set list may include a TRS resource, a CSI-RS resource set with repetition activated, or a CSI-RS resource set with activation deactivated. In some aspects, each CSI-RS resource or resource set of the list may be associated with a respective action (for example, P2 CSI-RS beam management, P3 CSI-RS beam management, or TRS measurement or reporting, among other examples). Each CSI-RS resource set may be associated with a respective report quantity corresponding to the respective action. In some aspects, a reporting configuration for the measurement report, associated with the CSI-RS resource set list, may be activated by the TCI state activation MAC-CE.

In some aspects, each CSI-RS resource set with a floating TCI state, as described above, may be further associated with a reporting configuration. The association between a CSI-RS resource set and a reporting configuration can be configured by signaling or by a rule. In some aspects, a report quantity of the reporting configuration may be configured as undefined. For example, the reporting configuration may have a floating quantity, meaning that the report quantity may be derived from the rule or the configured association. In such examples, the rule may indicate the report quantity based at least in part on an action associated with the measurement report. “Reporting configuration” is used interchangeably with “report configuration” herein.

In some aspects, each CSI-RS resource set of the pre-defined CSI-RS resource set list may be associated with a reporting configuration, and each CSI-RS resource set may be associated with an action (for example, one CSI-RS resource set for P2 CSI-RS beam management, one CSI-RS resource set for P3 CSI-RS beam management, and so on). In such examples, the CSI-RS resource sets of the CSI-RS resource set list may have a floating TCI state, as described above. This may reduce the quantity of configured CSI-RS resource sets from the quantity of configured TCI states to the quantity of action types. In such examples, the UE 120 may receive signaling (such as dynamic signaling or RRC down-selection) indicating which CSI-RS resource set and reporting configuration is to be used. In some other aspects, the TCI state activation MAC-CE may indicate which CSI-RS resource set and reporting configuration is to be used.

In some aspects (not illustrated in FIG. 5), the TCI state activation MAC-CE may trigger the UE 120 to transmit a reference signal, such as an SRS. In some aspects, the UE 120 may have (for example, be pre-configured with, be hardcoded with) information indicating a rule defining an association between an SRS resource or an SRS resource set and a TCI state. As one example, the rule may indicate that the triggered SRS is identified based at least in part on a source reference signal of the indicated TCI state of the indication to switch the beam. As another example, the rule may indicate that the triggered SRS is identified based at least in part on the indicated TCI state of the indication to switch the beam. As yet another example, the rule may indicate that the triggered SRS is identified based at least in part on an SRS resource set with a floating TCI state (or floating spatial relation information, such as a floating SRS resource indicator).

In a fifth operation 525, the base station 110 may transmit, and the UE 120 may receive, one or more reference signals. For example, the TCI state activation MAC-CE trigger a measurement of a reference signal for a TCI state indicated by the TCI state activation MAC-CE. The reference signal (for example, a resource or resource set associated with the reference signal) may be associated with, or linked to, the TCI state as described in more detail elsewhere herein (such as via signaling or via a rule). The TCI state activation MAC-CE trigger a measurement of other reference signals for other TCI states indicated by the TCI state activation MAC-CE in a similar manner. In other words, a single TCI state activation MAC-CE may trigger a measurement of different reference signals associated with different TCI states. Although some examples herein may describe a single reference signal and a single TCI state, the TCI state activation MAC-CE may trigger the measurement of multiple reference signals or may trigger a transmission of multiple measurement reports in a similar manner.

For example, the one or more reference signals transmitted by the base station 110 may be signals to be measured by the UE 120 (for example, as part of a beam measurement or a beam management procedure triggered by the TCI state activation MAC-CE). For example, the one or more reference signals may be CSI-RSs or TRSs, among other examples. The UE 120 may identify a timing of the transmission of a reference signal based at least in part on the configuration information (for example, based at least in part on a CSI report configuration). In some aspects, the UE 120 may identify a timing of the transmission of a reference signal based at least in part on a timing of the TCI state activation MAC-CE. For example, a timing offset for the reference signal may be relative to the timing of the TCI state activation MAC-CE. In some aspects, the timing offset for the reference signal may be relative to a timing of ACK feedback associated with the TCI state activation MAC-CE. In some aspects, a periodicity or a timing offset of a reference signal (such as a CSI-RS) or a corresponding measurement report (such as a CSI report) may be configured, such as via RRC signaling, or may be indicated by the TCI state activation MAC-CE.

In a sixth operation 530, the UE 120 may measure the one or more reference signals transmitted by the base station 110. For example, the UE 120 may perform RSRP, RSRQ, or other Layer 1 measurements of the one or more reference signals. In some aspects, the UE 120 may perform the measurements based at least in part on a report configuration associated with the one or more reference signals. For example, the UE 120 may perform one or more measurements of a reference signal in accordance with a beam management procedure that is triggered by the TCI state activation MAC-CE. For example, a TCI state activated by the TCI state activation MAC-CE may be associated with (or linked to) a beam management procedure or a reference signal resource set. By receiving the TCI state activation MAC-CE, the UE 120 may be triggered to measure the reference signal associated with the reference signal resource set or may be triggered to perform the beam management procedure.

In a seventh operation 535, the UE 120 may optionally transmit, and the base station 110 may receive, a measurement report indicating one or more measurements of the reference signal(s). For example, the UE 120 may transmit the measurement report if a configuration or a resource associated with the measurement report is associated with the TCI state indicated by the TCI state activation MAC-CE. The UE 120 may use the configuration or the resource associated with the measurement report to transmit the measurement report. In some aspects, the UE 120 may not transmit a measurement report. For example, the UE 120 may be triggered to measure a reference signal without transmitting a measurement report, as described elsewhere herein. In this way, the base station 110 configures an association between a beam (for example, a TCI state) and a corresponding reference signal (for example, to be measured by the UE 120) or measurement report, which enables triggering of the corresponding reference signal or measurement report using a TCI state activation MAC-CE.

In some aspects, the UE 120 may transmit the measurement report using one or more transmission parameters. The one or more transmission parameters may include a TDRA, an FDRA, a HARQ process identifier, or an MCS, among other examples. In some aspects, the one or more transmission parameters may be indicated by the configuration information (for example, an RRC configuration). For example, in some aspects, the configuration information may indicate one or more measurement reporting configurations (for example, CSI reporting configurations). For example, the configuration information may indicate one or more trigger states. Each trigger state may be associated with one or more CSI report configurations. Each CSI report configuration may indicate a channel associated with the CSI report configuration (for example, the PUCCH or the PUSCH), a reporting resource (for example, a resource to be used to transmit the measurement report), a reference signal resource configuration (for example, a CSI resource list), a report quantity (for example, indicating whether a measurement report is to be transmitted after measurement the reference signal indicated by the reference signal resource configuration), or scheduling type associated with the CSI report configuration (for example, aperiodic, semi-persistent, or periodic), among other examples. In some aspects, a CSI report configuration may indicate one or more transmission parameters to be used for transmitting the measurement report. The CSI report configuration may indicate the TDRA, the FDRA, or the MCS, among other examples, to be used by the UE 120 to transmit the measurement report.

For a measurement report to be transmitted using the uplink shared channel (for example, the PUSCH), the CSI report configuration may indicate a timing offset associated with the reference signal (for example, with the CSI-RS or the TRS). However, one or more transmission parameters for the measurement report may be indicated by the message that triggers the beam measurement or the measurement report. For example, a TDRA, an FDRA, an MCS, or a HARQ process identifier to be used to transmit the measurement report may be indicated by a downlink message that triggers or activates the CSI report configuration associated with the measurement report. For example, a downlink message may indicate a timing offset value associated with the measurement report that indicates an amount of time from a transmission of the downlink message (for example, that triggers or activates the CSI report configuration) by the base station 110 to a transmission of the measurement report by the UE 120. The timing offset value may be indicated by identifying an entry in a TDRA table configured by the configuration information (for example, the downlink message may identify the entry in the TDRA table, and the UE 120 may perform a lookup operation to identify the timing offset value from a configured TDRA table). Additionally, the downlink message (for example, that triggers or activates the CSI report configuration) may indicate an FDRA or an MCS, among other examples, to be used by the UE 120 to transmit the measurement report.

The configuration information may indicate that some transmission parameters for the measurement report (for example, that are not indicated by the configuration information) may be indicated by a downlink message (for example, DCI) or may be indicated by the TCI state activation MAC-CE. For example, the UE 120 may receive an indication of one or more transmission parameters to be used to transmit the measurement report and may receive the indication to active the one or more TCI states in the same message (for example, in the TCI state activation MAC-CE). In other words, the indication of the one or more transmission parameters and the indication to activate the one or more TCI states for the UE 120 may transmitted in the in the TCI state activation MAC-CE. This may conserve resources that would have otherwise been used by the base station 110 to indicate transmission parameters for the measurement report in a separate message. In some other aspects, the UE 120 may identify the one or more transmission parameters based at least in part on another downlink message, such as a DCI message or a message scheduled by DCI.

In some other aspects, at least one transmission parameter may be based at least in part on a rule. For example, the UE 120 may identify a transmission parameter to be used to transmit the measurement report on the PUSCH based at least in part on a rule. The rule may be defined by the base station 110 (for example, in the configuration information or in the TCI state activation MAC-CE) or may be defined by a wireless communication standard, such as the 3GPP. For example, a rule may indicate a given transmission parameter that is to be used when a measurement report (for example, a CSI measurement report) is triggered by a TCI state activation MAC-CE. For example, a rule may indicate a given MCS to be used for a measurement report (for example, a CSI measurement report) that is triggered by a TCI state activation MAC-CE. As another example, a rule may indicate a timing offset value, from a list of RRC configured timing offset values, that is to be used for a measurement report (for example, a CSI measurement report) that is triggered by a TCI state activation MAC-CE.

In an eighth operation 540, the UE 120 and the base station 110 may activate a TCI state indicated by the TCI state activation MAC-CE. For example, where the TCI state is not included in a list of actived TCI states and where the TCI state is known to the UE 120, the UE 120 and the base station 110 may active the TCI state an amount of time after the transmission of the one or more reference signals associated with the TCI state (for example, that were transmitted in the fifth operation 525). The amount of time may be based at least in part on a processing time associated with the UE 120 processing the received reference signal(s). Therefore, the activation time for the TCI state may be reduced because the delay associated with activating the TCI state may be based at least in part on a timing offset associated with the transmission of the reference signal(s) and the processing time of the UE 120. For example, the activation time for the TCI state may not be based on a transmission of a next SSB associated with the TCI state (which could be up to 20 milliseconds or 160 slots from the transmission of the TCI state activation MAC-CE). In other words, the processing times for the SSB and the reference signal may be approximately the same, but the scheduling offset associated with the reference signal (relative to the transmission of the TCI state activation MAC-CE) may be less than an amount of time until a transmission of the next SSB associated with the TCI state (relative to the transmission of the TCI state activation MAC-CE). As a result, a latency or a delay associated with activating the TCI state may be reduced.

In some aspects (not shown in FIG. 5), the base station 110 may deactivate one or more TCI states. For example, the base station 110 may transmit, and the UE 120 may receive, an indication to deactivate a TCI state that was activated by the TCI state activation MAC-CE. In some aspects, TCI state activation MAC-CE may have triggered periodic or semi-persistent measurement activities or measurement reports associated with the TCI state, as described in more detail elsewhere herein. In such examples, the indication to deactivate the TCI state may also deactivate any periodic or semi-persistent measurement activities or measurement reports associated with the TCI state (that were triggered by the TCI state activation MAC-CE). For example, the indication to deactivate the TCI state may also deactivate, at the UE 120, a transmission of a semi-persistent measurement report. This conserves resources that would have otherwise been used by the base station 110 to transmit an additional message to deactivate any periodic or semi-persistent measurement activities or measurement reports that were triggered by the TCI state activation MAC-CE.

In some aspects (not illustrated in FIG. 5), the TCI state activation MAC-CE may trigger the UE 120 to transmit a reference signal such as an SRS. In some aspects, the base station 110 may signal configuration information indicating an association between an SRS resource or an SRS resource set and a TCI state. For example, the association can be based at least in part on an SRS resource set identifier or an aperiodic SRS trigger state codepoint (such as an index for a trigger state).

As a result, the base station 110 may be enabled to active multiple TCI states in a TCI state activation MAC-CE. The base station 110 may be enabled to trigger a beam measurement or a measurement report for at least one TCI state (or multiple TCI states) indicated by the TCI state activation MAC-CE. In some aspects, the base station 110 may additionally indicate an association between TCI states and beam management procedures, reference signal resource or resource sets, or measurement report configuration via the TCI state activation MAC-CE. This may provide additional flexibility for the base station 110 (because the association(s) may be more dynamically indicated than if the association(s) were indicated in an RRC configuration or based on a pre-configured rule). Additionally, this may conserve resources that would have otherwise been used to indicate the association(s) and the indication to active the one or more TCI states in separate messages. Further, the base station 110 may be enabled to reduce a latency or a delay associated with activating a TCI state by triggering a measurement of a reference signal that may be transmitted earlier than a next SSB associated with the TCI state, thereby enabling the UE 120 and the base station 110 to activate the TCI state for the PDSCH faster than if the UE 120 were to wait to receive the SSB before activating the TCI state.

FIG. 6 is a flowchart illustrating an example process 600 performed, for example, by a UE associated with MAC signaling triggering a TCI state update or activation and a beam measurement or report, in accordance with the present disclosure. Example process 600 is an example where the UE (for example, UE 120) performs operations associated with MAC signaling triggering a TCI state update or activation and a beam measurement or report.

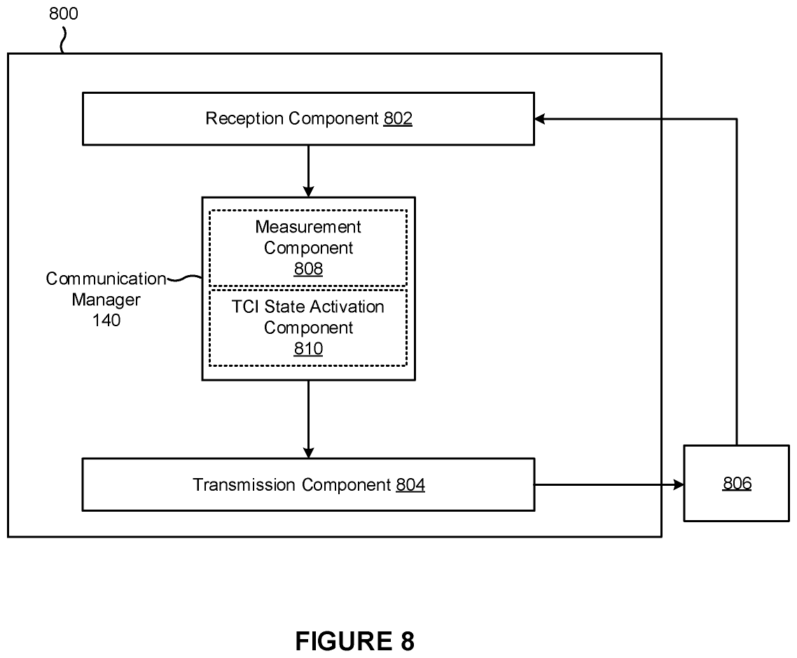

As shown in FIG. 6, in some aspects, process 600 may include receiving, via MAC signaling, an indication to activate one or more TCI states for the UE, wherein the indication triggers at least one of a measurement of a reference signal or a transmission of a measurement report for at least one TCI state of the one or more TCI states, wherein the reference signal or the transmission of the measurement report is triggered based at least in part on an association of a TCI state, from the at least one TCI state, with the reference signal or the measurement report (block 610). For example, the UE (such as by using communication manager 140 or reception component 802, depicted in FIG. 8) may receive, via MAC signaling, an indication to activate one or more TCI states for the UE, wherein the indication triggers at least one of a measurement of a reference signal or a transmission of a measurement report for at least one TCI state of the one or more TCI states, wherein the reference signal or the transmission of the measurement report is triggered based at least in part on an association of a TCI state, from the at least one TCI state, with the reference signal or the measurement report, as described above.

As further shown in FIG. 6, in some aspects, process 600 may include receiving the reference signal based at least in part on receiving the indication to activate the one or more TCI states (block 620). For example, the UE (such as by using communication manager 140 or reception component 802, depicted in FIG. 8) may receive the reference signal based at least in part on receiving the indication to activate the one or more TCI states, as described above.

As further shown in FIG. 6, in some aspects, process 600 may include transmitting the measurement report based on the indication triggering the transmission of the measurement report, wherein the measurement report indicates a measurement of the reference signal (block 630). For example, the UE (such as by using communication manager 140 or transmission component 804, depicted in FIG. 8) may transmit the measurement report based on the indication triggering the transmission of the measurement report, wherein the measurement report indicates a measurement of the reference signal, as described above.

Process 600 may include additional aspects, such as any single aspect or any combination of aspects described below or in connection with one or more other processes described elsewhere herein.

In a first additional aspect, receiving the indication to activate the one or more TCI states for the UE includes receiving a MAC-CE message that includes the indication to activate the one or more TCI states.

In a second additional aspect, alone or in combination with the first aspect, receiving the indication to activate the one or more TCI states for the UE includes receiving an indication of multiple TCI states that are to be activated for the UE.

In a third additional aspect, alone or in combination with one or more of the first and second aspects, the indication triggers at least one of a measurement of a reference signal or a transmission of a measurement report for each TCI state of the multiple TCI states.

In a fourth additional aspect, alone or in combination with one or more of the first through third aspects, the indication triggers at least one of a measurement of a reference signal or a transmission of a measurement report for each TCI state of a subset of TCI states of the multiple TCI states.

In a fifth additional aspect, alone or in combination with one or more of the first through fourth aspects, the indication to activate the one or more TCI states activates, for the TCI state, a semi-persistent measurement report, and process 600 includes receiving an indication to deactivate the TCI state, wherein the indication to deactivate the TCI state deactivates a transmission of the semi-persistent measurement report.

In a sixth additional aspect, alone or in combination with one or more of the first through fifth aspects, process 600 includes receiving a set of activated TCI states prior to receiving the indication to activate the one or more TCI states, wherein the TCI state is not included in the set of activated TCI states, and receiving the reference signal includes receiving the reference signal after a first amount of time relative to receiving the indication to activate the one or more TCI states, wherein the first amount of time is based at least in part on a scheduling offset value associated with the reference signal.

In a seventh additional aspect, alone or in combination with one or more of the first through sixth aspects, process 600 includes activating the TCI state after a second amount of time relative to receiving the reference signal, wherein the second amount of time is based at least in part on a processing time associated with receiving the reference signal.

In an eighth additional aspect, alone or in combination with one or more of the first through seventh aspects, process 600 includes receiving configuration information configuring the association of the TCI state with the reference signal or the measurement report.

In a ninth additional aspect, alone or in combination with one or more of the first through eighth aspects, process 600 includes receiving configuration information configuring the association and the indication to activate the one or more TCI states in a same message.

In a tenth additional aspect, alone or in combination with one or more of the first through ninth aspects, process 600 includes receiving configuration information configuring the association via RRC signaling.

In an eleventh additional aspect, alone or in combination with one or more of the first through tenth aspects, process 600 includes receiving configuration information configuring the association, wherein the configuration information indicates that the TCI state is associated with a codepoint of a trigger state associated with the measurement report.

In a twelfth additional aspect, alone or in combination with one or more of the first through eleventh aspects, process 600 includes receiving configuration information configuring the association, wherein the configuration information indicates that the TCI state is associated with a report configuration of the measurement report.

In a thirteenth additional aspect, alone or in combination with one or more of the first through twelfth aspects, the association is based at least in part on a rule.

In a fourteenth additional aspect, alone or in combination with one or more of the first through thirteenth aspects, process 600 includes receiving signaling activating the rule.

In a fifteenth additional aspect, alone or in combination with one or more of the first through fourteenth aspects, the rule is preconfigured or is defined in a wireless communication specification.

In a sixteenth additional aspect, alone or in combination with one or more of the first through fifteenth aspects, the rule indicates the reference signal to be measured by the UE or the measurement report to be transmitted by the UE based at least in part on a source reference signal of a beam used by the UE.

In a seventeenth additional aspect, alone or in combination with one or more of the first through sixteenth aspects, the rule indicates the reference signal to be measured by the UE based at least in part on the TCI state.

In an eighteenth additional aspect, alone or in combination with one or more of the first through seventeenth aspects, the rule indicates a mapping, for each TCI state of the one or more TCI states, of TCI states with one or more reference signal resources or reference signal resource sets of the reference signal, and wherein the mapping is based at least in part on a prioritization rule for reference signal resources or reference signal resource sets.

In a nineteenth additional aspect, alone or in combination with one or more of the first through eighteenth aspects, the reference signal is associated with a group of reference signal resource sets that are activated by receiving the indication to activate the one or more TCI states, wherein a TCI state of the group of reference signal resource sets is configured as undefined, and wherein the rule indicates that the group of reference signal resource sets are to use the TCI state.

In a twentieth additional aspect, alone or in combination with one or more of the first through nineteenth aspects, a report quantity of a reporting configuration of the measurement report is configured as undefined, and wherein the rule indicates the report quantity based at least in part on an action associated with the measurement report.

In a twenty-first additional aspect, alone or in combination with one or more of the first through twentieth aspects, the measurement report is associated with an uplink shared channel, and process 600 includes receiving an indication of one or more transmission parameters to be used by the UE to transmit the measurement report on the uplink shared channel.

In a twenty-second additional aspect, alone or in combination with one or more of the first through twenty-first aspects, the indication of the one or more transmission parameters and the indication to activate the one or more TCI states for the UE are received in a same message.

In a twenty-third additional aspect, alone or in combination with one or more of the first through twenty-second aspects, the same message is a MAC control element message.

In a twenty-fourth additional aspect, alone or in combination with one or more of the first through twenty-third aspects, the one or more transmission parameters include at least one of a time domain resource allocation for the measurement report, a frequency domain resource allocation for the measurement report, a modulation and coding scheme for the measurement report, or a HARQ process identifier associated with the measurement report.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a flowchart illustrating an example process 700 performed, for example, by a base station associated with MAC signaling triggering a TCI state update or activation and a beam measurement or report, in accordance with the present disclosure. Example process 700 is an example where the base station (for example, base station 110) performs operations associated with MAC signaling triggering a TCI state update or activation and a beam measurement or report.

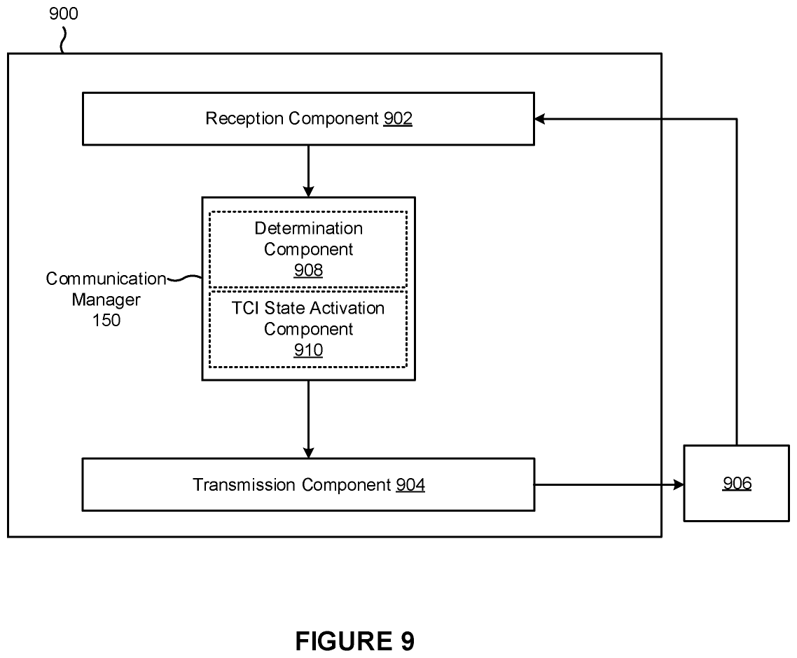

As shown in FIG. 7, in some aspects, process 700 may include transmitting, to a UE via MAC signaling, an indication to activate one or more TCI states for the UE, wherein the indication triggers at least one of a measurement of a reference signal or a transmission of a measurement report by the UE for at least one TCI state of the one or more TCI states, wherein the reference signal or the transmission of the measurement report is triggered based at least in part on an association of a TCI state, from the at least one TCI state, with the reference signal or the measurement report (block 710). For example, the base station (such as by using communication manager 150 or transmission component 904, depicted in FIG. 9) may transmit, to a UE via MAC signaling, an indication to activate one or more TCI states for the UE, wherein the indication triggers at least one of a measurement of a reference signal or a transmission of a measurement report by the UE for at least one TCI state of the one or more TCI states, wherein the reference signal or the transmission of the measurement report is triggered based at least in part on an association of a TCI state, from the at least one TCI state, with the reference signal or the measurement report, as described above.

As further shown in FIG. 7, in some aspects, process 700 may include transmitting the reference signal based at least in part on transmitting the indication to activate the one or more TCI states (block 720). For example, the base station (such as by using communication manager 150 or transmission component 904, depicted in FIG. 9) may transmit the reference signal based at least in part on transmitting the indication to activate the one or more TCI states, as described above.

As further shown in FIG. 7, in some aspects, process 700 may include receiving the measurement report based on the indication triggering the transmission of the measurement report, wherein the measurement report indicates a measurement of the reference signal (block 730). For example, the base station (such as by using communication manager 150 or reception component 902, depicted in FIG. 9) may receive the measurement report based on the indication triggering the transmission of the measurement report, wherein the measurement report indicates a measurement of the reference signal, as described above.

Process 700 may include additional aspects, such as any single aspect or any combination of aspects described below or in connection with one or more other processes described elsewhere herein.

In a first additional aspect, transmitting the indication to activate the one or more TCI states for the UE includes transmitting a MAC-CE message that includes the indication to activate the one or more TCI states.

In a second additional aspect, alone or in combination with the first aspect, transmitting the indication to activate the one or more TCI states for the UE includes transmitting an indication of multiple TCI states that are to be activated for the UE.

In a third additional aspect, alone or in combination with one or more of the first and second aspects, the indication triggers at least one of a measurement of a reference signal or a transmission of a measurement report for each TCI state of the multiple TCI states.

In a fourth additional aspect, alone or in combination with one or more of the first through third aspects, the indication triggers at least one of a measurement of a reference signal or a transmission of a measurement report for each TCI state of a subset of TCI states of the multiple TCI states.

In a fifth additional aspect, alone or in combination with one or more of the first through fourth aspects, the indication to activate the one or more TCI states activates, for the TCI state, a semi-persistent measurement report, and process 700 includes transmitting an indication to deactivate the TCI state, wherein the indication to deactivate the TCI state deactivates, at the UE, a transmission of the semi-persistent measurement report.

In a sixth additional aspect, alone or in combination with one or more of the first through fifth aspects, process 700 includes transmitting a set of activated TCI states prior to transmitting the indication to activate the one or more TCI states, wherein the TCI state is not included in the set of activated TCI states, and wherein transmitting the reference signal includes transmitting the reference signal after a first amount of time relative to transmitting the indication to activate the one or more TCI states, wherein the first amount of time is based at least in part on a scheduling offset value associated with the reference signal.

In a seventh additional aspect, alone or in combination with one or more of the first through sixth aspects, process 700 includes activating the TCI state after a second amount of time relative to transmitting the reference signal, wherein the second amount of time is based at least in part on a processing time associated with the UE receiving the reference signal.

In an eighth additional aspect, alone or in combination with one or more of the first through seventh aspects, process 700 includes transmitting configuration information configuring the association of the TCI state with the reference signal or the measurement report.

In a ninth additional aspect, alone or in combination with one or more of the first through eighth aspects, process 700 includes transmitting configuration information configuring the association and the indication to activate the one or more TCI states in a same message.

In a tenth additional aspect, alone or in combination with one or more of the first through ninth aspects, process 700 includes transmitting configuration information configuring the association via RRC signaling.

In an eleventh additional aspect, alone or in combination with one or more of the first through tenth aspects, process 700 includes transmitting configuration information configuring the association, wherein the configuration information indicates that the TCI state is associated with a codepoint of a trigger state associated with the measurement report.

In a twelfth additional aspect, alone or in combination with one or more of the first through eleventh aspects, process 700 includes transmitting configuration information configuring the association, wherein the configuration information indicates that the TCI state is associated with a report configuration of the measurement report.

In a thirteenth additional aspect, alone or in combination with one or more of the first through twelfth aspects, the association is based at least in part on a rule.

In a fourteenth additional aspect, alone or in combination with one or more of the first through thirteenth aspects, process 700 includes transmitting signaling activating the rule.

In a fifteenth additional aspect, alone or in combination with one or more of the first through fourteenth aspects, the rule is preconfigured or is defined in a wireless communication specification.

In a sixteenth additional aspect, alone or in combination with one or more of the first through fifteenth aspects, the rule indicates the to be measured by the UE or the measurement report to be transmitted by the UE based at least in part on a source reference signal of a beam used by the UE.

In a seventeenth additional aspect, alone or in combination with one or more of the first through sixteenth aspects, the rule indicates the reference signal to be measured by the UE based at least in part on the TCI state.

In an eighteenth additional aspect, alone or in combination with one or more of the first through seventeenth aspects, the rule indicates a mapping, for each TCI state of the one or more TCI states, of TCI states with one or more reference signal resources or reference signal resource sets of the reference signal, and wherein the mapping is based at least in part on a prioritization rule for reference signal resources or reference signal resource sets.

In a nineteenth additional aspect, alone or in combination with one or more of the first through eighteenth aspects, the reference signal is associated with a group of reference signal resource sets that are activated by receiving the indication to activate the one or more TCI states, wherein a TCI state of the group of reference signal resource sets is configured as undefined, and wherein the rule indicates that the group of reference signal resource sets are to use the TCI state.

In a twentieth additional aspect, alone or in combination with one or more of the first through nineteenth aspects, a report quantity of a reporting configuration of the measurement report is configured as undefined, and wherein the rule indicates the report quantity based at least in part on an action associated with the measurement report.

In a twenty-first additional aspect, alone or in combination with one or more of the first through twentieth aspects, the measurement report is associated with an uplink shared channel, and process 700 includes transmitting an indication of one or more transmission parameters to be used by the UE to transmit the measurement report on the uplink shared channel.

In a twenty-second additional aspect, alone or in combination with one or more of the first through twenty-first aspects, the indication of the one or more transmission parameters and the indication to activate the one or more TCI states for the UE are transmitted in a same message.

In a twenty-third additional aspect, alone or in combination with one or more of the first through twenty-second aspects, the same message is a MAC control element message.

In a twenty-fourth additional aspect, alone or in combination with one or more of the first through twenty-third aspects, the one or more transmission parameters include at least one of a time domain resource allocation for the measurement report, a frequency domain resource allocation for the measurement report, a modulation and coding scheme for the measurement report, or a HARQ process identifier associated with the measurement report.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a diagram of an example apparatus 800 for wireless communication in accordance with the present disclosure. The apparatus 800 may be a UE, or a UE may include the apparatus 800. In some aspects, the apparatus 800 includes a reception component 802, a transmission component 804, and a communication manager 140, which may be in communication with one another (for example, via one or more buses).

As shown, the apparatus 800 may communicate with another apparatus 806 (such as a UE, a base station, or another wireless communication device) using the reception component 802 and the transmission component 804.

In some aspects, the apparatus 800 may be configured to perform one or more operations described herein in connection with FIG. 5. Additionally or alternatively, the apparatus 800 may be configured to perform one or more processes described herein, such as process 600 of FIG. 6, or a combination thereof. In some aspects, the apparatus 800 may include one or more components of the UE described above in connection with FIG. 2.

The reception component 802 may receive communications, such as reference signals, control information, data communications, or a combination thereof, from the apparatus 806. The reception component 802 may provide received communications to one or more other components of the apparatus 800, such as the communication manager 140. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 802 may include one or more antennas, a modem, a demodulator, a MIMO detector, a receive processor, a controller/processor, a memory, or a combination thereof, of the UE described above in connection with FIG. 2.

The transmission component 804 may transmit communications, such as reference signals, control information, data communications, or a combination thereof, to the apparatus 806. In some aspects, the communication manager 140 may generate communications and may transmit the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described above in connection with FIG. 2. In some aspects, the transmission component 804 may be co-located with the reception component 802 in a transceiver.

The communication manager 140 may receive or may cause the reception component 802 to receive, via MAC signaling, an indication to activate one or more TCI states for the UE, wherein the indication triggers at least one of a measurement of a reference signal or a transmission of a measurement report for at least one TCI state of the one or more TCI states, wherein the reference signal or the transmission of the measurement report is triggered based at least in part on an association of a TCI state, from the at least one TCI state, with the reference signal or the measurement report. The communication manager 140 may receive or may cause the reception component 802 to receive the reference signal based at least in part on receiving the indication to activate the one or more TCI states. The communication manager 140 may transmit or may cause the transmission component 804 to transmit the measurement report based on the indication triggering the transmission of the measurement report, wherein the measurement report indicates a measurement of the reference signal. In some aspects, the communication manager 140 may perform one or more operations described elsewhere herein as being performed by one or more components of the communication manager 140.

The communication manager 140 may include a controller/processor, a memory, or a combination thereof, of the UE described above in connection with FIG. 2. In some aspects, the communication manager 140 includes a set of components, such as a measurement component 808, a TCJ state activation component 810, or a combination thereof. Alternatively, the set of components may be separate and distinct from the communication manager 140. In some aspects, one or more components of the set of components may include or may be implemented within a controller/processor, a memory, or a combination thereof, of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive, via MAC signaling, an indication to activate one or more TCJ states for the apparatus 800, wherein the indication triggers at least one of a measurement of a reference signal or a transmission of a measurement report for at least one TCJ state of the one or more TCJ states, wherein the reference signal or the transmission of the measurement report is triggered based at least in part on an association of a TCJ state, from the at least one TCJ state, with the reference signal or the measurement report. The reception component 802 may receive the reference signal based at least in part on receiving the indication to activate the one or more TCJ states.

The transmission component 804 may transmit the measurement report based on the indication triggering the transmission of the measurement report, wherein the measurement report indicates a measurement of the reference signal.

The measurement component 808 may perform one or more measurements of the reference signal based at least in part on the association of the TCJ state with the reference signal or the measurement report.

The reception component 802 may receive a set of activated TCJ states prior to receiving the indication to activate the one or more TCJ states, wherein the TCJ state is not included in the set of activated TCJ states wherein receiving the reference signal comprises receiving the reference signal after a first amount of time relative to receiving the indication to activate the one or more TCJ states, wherein the first amount of time is based at least in part on a scheduling offset value associated with the reference signal.

The TCI state activation component 810 may activate the TCI state after a second amount of time relative to receiving the reference signal, wherein the second amount of time is based at least in part on a processing time associated with receiving the reference signal.

The reception component 802 may receive configuration information configuring the association of the TCI state with the reference signal or the measurement report.

The reception component 802 may receive configuration information configuring the association and the indication to activate the one or more TCI states in a same message.

The reception component 802 may receive configuration information configuring the association via RRC signaling.

The reception component 802 may receive configuration information configuring the association, wherein the configuration information indicates that the TCI state is associated with a codepoint of a trigger state associated with the measurement report.

The reception component 802 may receive configuration information configuring the association, wherein the configuration information indicates that the TCI state is associated with a report configuration of the measurement report.

The reception component 802 may receive signaling activating a rule, wherein the association is based at least in part on the rule.

The quantity and arrangement of components shown in FIG. 8 are provided as an example. In practice, there may be additional components, fewer components, different components, or differently arranged components than those shown in FIG. 8.

Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

FIG. 9 is a diagram of an example apparatus 900 for wireless communication in accordance with the present disclosure. The apparatus 900 may be a base station, or a base station may include the apparatus 900. In some aspects, the apparatus 900 includes a reception component 902, a transmission component 904, and a communication manager 150, which may be in communication with one another (for example, via one or more buses). As shown, the apparatus 900 may communicate with another apparatus 906 (such as a UE, a base station, or another wireless communication device) using the reception component 902 and the transmission component 904.

In some aspects, the apparatus 900 may be configured to perform one or more operations described herein in connection with FIG. 5. Additionally or alternatively, the apparatus 900 may be configured to perform one or more processes described herein, such as process 700 of FIG. 7, or a combination thereof. In some aspects, the apparatus 900 may include one or more components of the base station described above in connection with FIG. 2.

The reception component 902 may receive communications, such as reference signals, control information, data communications, or a combination thereof, from the apparatus 906. The reception component 902 may provide received communications to one or more other components of the apparatus 900, such as the communication manager 150. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 902 may include one or more antennas, a modem, a demodulator, a MIMO detector, a receive processor, a controller/processor, a memory, or a combination thereof, of the base station described above in connection with FIG. 2.

The transmission component 904 may transmit communications, such as reference signals, control information, data communications, or a combination thereof, to the apparatus 906. In some aspects, the communication manager 150 may generate communications and may transmit the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the base station described above in connection with FIG. 2. In some aspects, the transmission component 904 may be co-located with the reception component 902 in a transceiver.

The communication manager 150 may transmit or may cause the transmission component 904 to transmit, to a UE via MAC signaling, an indication to activate one or more TCI states for the UE, wherein the indication triggers at least one of a measurement of a reference signal or a transmission of a measurement report by the UE for at least one TCI state of the one or more TCI states, wherein the reference signal or the transmission of the measurement report is triggered based at least in part on an association of a TCI state, from the at least one TCI state, with the reference signal or the measurement report. The communication manager 150 may transmit or may cause the transmission component 904 to transmit the reference signal based at least in part on transmitting the indication to activate the one or more TCI states. The communication manager 150 may receive or may cause the reception component 902 to receive the measurement report based on the indication triggering the transmission of the measurement report, wherein the measurement report indicates a measurement of the reference signal. In some aspects, the communication manager 150 may perform one or more operations described elsewhere herein as being performed by one or more components of the communication manager 150.

The communication manager 150 may include a controller/processor, a memory, a scheduler, a communication unit, or a combination thereof, of the base station described above in connection with FIG. 2. In some aspects, the communication manager 150 includes a set of components, such as a determination component 908, a TCI state activation component 910, or a combination thereof. Alternatively, the set of components may be separate and distinct from the communication manager 150. In some aspects, one or more components of the set of components may include or may be implemented within a controller/processor, a memory, a scheduler, a communication unit, or a combination thereof, of the base station described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 904 may transmit, to a UE via MAC signaling, an indication to activate one or more TCI states for the UE, wherein the indication triggers at least one of a measurement of a reference signal or a transmission of a measurement report by the UE for at least one TCI state of the one or more TCI states, wherein the reference signal or the transmission of the measurement report is triggered based at least in part on an association of a TCI state, from the at least one TCI state, with the reference signal or the measurement report. The transmission component 904 may transmit the reference signal based at least in part on transmitting the indication to activate the one or more TCI states. The reception component 902 may receive the measurement report based on the indication triggering the transmission of the measurement report, wherein the measurement report indicates a measurement of the reference signal.

The determination component 908 may determine the association of the TCI state with the reference signal or the measurement report.

The transmission component 904 may transmit a set of activated TCI states prior to transmitting the indication to activate the one or more TCI states, wherein the TCI state is not included in the set of activated TCI states wherein transmitting the reference signal comprises transmitting the reference signal after a first amount of time relative to transmitting the indication to activate the one or more TCI states, wherein the first amount of time is based at least in part on a scheduling offset value associated with the reference signal.

The TCI state activation component 910 may activate the TCI state after a second amount of time relative to transmitting the reference signal, wherein the second amount of time is based at least in part on a processing time associated with the UE receiving the reference signal.

The transmission component 904 may transmit configuration information configuring the association of the TCI state with the reference signal or the measurement report.

The transmission component 904 may transmit configuration information configuring the association and the indication to activate the one or more TCI states in a same message.

The transmission component 904 may transmit configuration information configuring the association via RRC signaling.

The transmission component 904 may transmit configuration information configuring the association, wherein the configuration information indicates that the TCI state is associated with a codepoint of a trigger state associated with the measurement report.

The transmission component 904 may transmit configuration information configuring the association, wherein the configuration information indicates that the TCI state is associated with a report configuration of the measurement report.

The transmission component 904 may transmit signaling activating a rule, wherein the association is based at least in part on the rule.

The quantity and arrangement of components shown in FIG. 9 are provided as an example. In practice, there may be additional components, fewer components, different components, or differently arranged components than those shown in FIG. 9.

Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving, via medium access control (MAC) signaling, an indication to activate one or more transmission configuration indicator (TCI) states for the UE, wherein the indication triggers at least one of a measurement of a reference signal or a transmission of a measurement report for at least one TCI state of the one or more TCI states, wherein the reference signal or the transmission of the measurement report is triggered based at least in part on an association of a TCI state, from the at least one TCI state, with the reference signal or the measurement report; receiving the reference signal based at least in part on receiving the indication to activate the one or more TCI states; and transmitting the measurement report based at least in part on the indication triggering the transmission of the measurement report, wherein the measurement report indicates a measurement of the reference signal.

Aspect 2: The method of Aspect 1, wherein receiving the indication to activate the one or more TCI states for the UE comprises receiving a MAC control element (MAC-CE) message that includes the indication to activate the one or more TCI states.

Aspect 3: The method of any of Aspects 1-2, wherein receiving the indication to activate the one or more TCI states for the UE comprises receiving an indication of multiple TCI states that are to be activated for the UE.

Aspect 4: The method of Aspect 3, wherein the indication triggers at least one of a measurement of a reference signal or a transmission of a measurement report for each TCI state of the multiple TCI states.

Aspect 5: The method of Aspect 3, wherein the indication triggers at least one of a measurement of a reference signal or a transmission of a measurement report for each TCI state of a subset of TCI states of the multiple TCI states.

Aspect 6: The method of any of Aspects 1-5, wherein the indication to activate the one or more TCI states activates, for the TCI state, a semi-persistent measurement report, the method further comprising receiving an indication to deactivate the TCI state, wherein the indication to deactivate the TCI state deactivates a transmission of the semi-persistent measurement report.

Aspect 7: The method of any of Aspects 1-6, further comprising receiving a set of activated TCI states prior to receiving the indication to activate the one or more TCI states, wherein the TCI state is not included in the set of activated TCI states, and wherein receiving the reference signal comprises receiving the reference signal after a first amount of time relative to receiving the indication to activate the one or more TCI states, wherein the first amount of time is based at least in part on a scheduling offset value associated with the reference signal.

Aspect 8: The method of Aspect 7, further comprising: activating the TCI state after a second amount of time relative to receiving the reference signal, wherein the second amount of time is based at least in part on a processing time associated with receiving the reference signal.

Aspect 9: The method of any of Aspects 1-8, further comprising receiving configuration information configuring the association of the TCI state with the reference signal or the measurement report.

Aspect 10: The method of any of Aspects 1-9, further comprising receiving configuration information configuring the association and the indication to activate the one or more TCI states in a same message.

Aspect 11: The method of any of Aspects 1-9, further comprising receiving configuration information configuring the association via radio resource control (RRC) signaling.

Aspect 12: The method of any of Aspects 1-11, further comprising receiving configuration information configuring the association, wherein the configuration information indicates that the TCI state is associated with a codepoint of a trigger state associated with the measurement report.

Aspect 13: The method of any of Aspects 1-12, further comprising receiving configuration information configuring the association, wherein the configuration information indicates that the TCI state is associated with a report configuration of the measurement report.

Aspect 14: The method of any of Aspects 1-13, wherein the association is based at least in part on a rule.

Aspect 15: The method of Aspect 14, further comprising receiving signaling activating the rule.

Aspect 16: The method of any of Aspects 14-15, wherein the rule is preconfigured or is defined in a wireless communication specification.

Aspect 17: The method of any of Aspects 14-16, wherein the rule indicates the reference signal to be measured by the UE or the measurement report to be transmitted by the UE based at least in part on a source reference signal of a beam used by the UE.

Aspect 18: The method of any of Aspects 14-17, wherein the rule indicates the reference signal to be measured by the UE based at least in part on the TCI state.

Aspect 19: The method of any of Aspects 14-18, wherein the rule indicates a mapping, for each TCI state of the one or more TCI states, of TCI states with one or more reference signal resources or reference signal resource sets of the reference signal, and wherein the mapping is based at least in part on a prioritization rule for reference signal resources or reference signal resource sets.

Aspect 20: The method of any of Aspects 14-19, wherein the reference signal is associated with a group of reference signal resource sets that are activated by receiving the indication to activate the one or more TCI states, wherein a TCI state of the group of reference signal resource sets is configured as undefined, and wherein the rule indicates that the group of reference signal resource sets are to use the TCI state.

Aspect 21: The method of Aspect 20, wherein a report quantity of a reporting configuration of the measurement report is configured as undefined, and wherein the rule indicates the report quantity based at least in part on an action associated with the measurement report.

Aspect 22: The method of any of Aspects 1-21, wherein the measurement report is associated with an uplink shared channel, the method further comprising: receiving an indication of one or more transmission parameters to be used by the UE to transmit the measurement report on the uplink shared channel.

Aspect 23: The method of Aspect 22, wherein the indication of the one or more transmission parameters and the indication to activate the one or more TCI states for the UE are received in a same message.

Aspect 24: The method of Aspect 23, wherein the same message is a MAC control element message.

Aspect 25: The method of any of Aspects 22-24, wherein the one or more transmission parameters include at least one of: a time domain resource allocation for the measurement report, a frequency domain resource allocation for the measurement report, a modulation and coding scheme for the measurement report, or a hybrid automatic repeat request (HARQ) process identifier associated with the measurement report.

Aspect 26: A method of wireless communication performed by a base station, comprising: transmitting, to a user equipment (UE) via medium access control (MAC) signaling, an indication to activate one or more transmission configuration indicator (TCI) states for the UE, wherein the indication triggers at least one of a measurement of a reference signal or a transmission of a measurement report by the UE for at least one TCI state of the one or more TCI states, wherein the reference signal or the transmission of the measurement report is triggered based at least in part on an association of a TCI state, from the at least one TCI state, with the reference signal or the measurement report; transmitting the reference signal based at least in part on transmitting the indication to activate the one or more TCI states; and receiving the measurement report based at least in part on the indication triggering the transmission of the measurement report, wherein the measurement report indicates a measurement of the reference signal.

Aspect 27: The method of Aspect 26, wherein transmitting the indication to activate the one or more TCI states for the UE comprises transmitting a MAC control element (MAC-CE) message that includes the indication to activate the one or more TCI states.

Aspect 28: The method of any of Aspects 26-27, wherein transmitting the indication to activate the one or more TCI states for the UE comprises transmitting an indication of multiple TCI states that are to be activated for the UE.

Aspect 29: The method of Aspect 28, wherein the indication triggers at least one of a measurement of a reference signal or a transmission of a measurement report for each TCI state of the multiple TCI states.

Aspect 30: The method of Aspect 28, wherein the indication triggers at least one of a measurement of a reference signal or a transmission of a measurement report for each TCI state of a subset of TCI states of the multiple TCI states.

Aspect 31: The method of any of Aspects 26-30, wherein the indication to activate the one or more TCI states activates, for the TCI state, a semi-persistent measurement report, the method further comprising transmitting an indication to deactivate the TCI state, wherein the indication to deactivate the TCI state deactivates, at the UE, a transmission of the semi-persistent measurement report.

Aspect 32: The method of any of Aspects 26-31, further comprising transmitting a set of activated TCI states prior to transmitting the indication to activate the one or more TCI states, wherein the TCI state is not included in the set of activated TCI states, and wherein transmitting the reference signal comprises transmitting the reference signal after a first amount of time relative to transmitting the indication to activate the one or more TCI states, wherein the first amount of time is based at least in part on a scheduling offset value associated with the reference signal.

Aspect 33: The method of Aspect 32, further comprising: activating the TCI state after a second amount of time relative to transmitting the reference signal, wherein the second amount of time is based at least in part on a processing time associated with the UE receiving the reference signal.

Aspect 34: The method of any of Aspects 26-33, further comprising transmitting configuration information configuring the association of the TCI state with the reference signal or the measurement report.

Aspect 35: The method of any of Aspects 26-34, further comprising transmitting configuration information configuring the association and the indication to activate the one or more TCI states in a same message.

Aspect 36: The method of any of Aspects 26-34, further comprising transmitting configuration information configuring the association via radio resource control (RRC) signaling.

Aspect 37: The method of any of Aspects 26-36, further comprising transmitting configuration information configuring the association, wherein the configuration information indicates that the TCI state is associated with a codepoint of a trigger state associated with the measurement report.

Aspect 38: The method of any of Aspects 26-37, further comprising transmitting configuration information configuring the association, wherein the configuration information indicates that the TCI state is associated with a report configuration of the measurement report.

Aspect 39: The method of any of Aspects 26-38, wherein the association is based at least in part on a rule.

Aspect 40: The method of Aspect 39, further comprising transmitting signaling activating the rule.

Aspect 41: The method of any of Aspects 39-40, wherein the rule is preconfigured or is defined in a wireless communication specification.

Aspect 42: The method of any of Aspects 39-41, wherein the rule indicates the to be measured by the UE or the measurement report to be transmitted by the UE based at least in part on a source reference signal of a beam used by the UE.

Aspect 43: The method of any of Aspects 39-42, wherein the rule indicates the reference signal to be measured by the UE based at least in part on the TCI state.

Aspect 44: The method of any of Aspects 39-43, wherein the rule indicates a mapping, for each TCI state of the one or more TCI states, of TCI states with one or more reference signal resources or reference signal resource sets of the reference signal, and wherein the mapping is based at least in part on a prioritization rule for reference signal resources or reference signal resource sets.

Aspect 45: The method of any of Aspects 39-44, wherein the reference signal is associated with a group of reference signal resource sets that are activated by receiving the indication to activate the one or more TCI states, wherein a TCI state of the group of reference signal resource sets is configured as undefined, and wherein the rule indicates that the group of reference signal resource sets are to use the TCI state.

Aspect 46: The method of Aspect 45, wherein a report quantity of a reporting configuration of the measurement report is configured as undefined, and wherein the rule indicates the report quantity based at least in part on an action associated with the measurement report.

Aspect 47: The method of any of Aspects 26-46, wherein the measurement report is associated with an uplink shared channel, the method further comprising: transmitting an indication of one or more transmission parameters to be used by the UE to transmit the measurement report on the uplink shared channel.

Aspect 48: The method of Aspect 47, wherein the indication of the one or more transmission parameters and the indication to activate the one or more TCI states for the UE are transmitted in a same message.

Aspect 49: The method of Aspect 48, wherein the same message is a MAC control element message.

Aspect 50: The method of any of Aspects 47-49, wherein the one or more transmission parameters include at least one of: a time domain resource allocation for the measurement report, a frequency domain resource allocation for the measurement report, a modulation and coding scheme for the measurement report, or a hybrid automatic repeat request (HARQ) process identifier associated with the measurement report.

Aspect 51: An apparatus for wireless communication at a device, comprising a processor; memory coupled with the processor; and instructions stored in the memory and executable by the processor to cause the apparatus to perform the method of one or more of Aspects 1-25.

Aspect 52: A device for wireless communication, comprising a memory and one or more processors coupled to the memory, the one or more processors configured to perform the method of one or more of Aspects 1-25.

Aspect 53: An apparatus for wireless communication, comprising at least one means for performing the method of one or more of Aspects 1-25.

Aspect 54: A non-transitory computer-readable medium storing code for wireless communication, the code comprising instructions executable by a processor to perform the method of one or more of Aspects 1-25.

Aspect 55: A non-transitory computer-readable medium storing a set of instructions for wireless communication, the set of instructions comprising one or more instructions that, when executed by one or more processors of a device, cause the device to perform the method of one or more of Aspects 1-25.

Aspect 56: An apparatus for wireless communication at a device, comprising a processor; memory coupled with the processor; and instructions stored in the memory and executable by the processor to cause the apparatus to perform the method of one or more of Aspects 26-50.

Aspect 57: A device for wireless communication, comprising a memory and one or more processors coupled to the memory, the one or more processors configured to perform the method of one or more of Aspects 26-50.

Aspect 58: An apparatus for wireless communication, comprising at least one means for performing the method of one or more of Aspects 26-50.

Aspect 59: A non-transitory computer-readable medium storing code for wireless communication, the code comprising instructions executable by a processor to perform the method of one or more of Aspects 26-50.

Aspect 60: A non-transitory computer-readable medium storing a set of instructions for wireless communication, the set of instructions comprising one or more instructions that, when executed by one or more processors of a device, cause the device to perform the method of one or more of Aspects 26-50.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, since those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A user equipment (UE) for wireless communication, comprising:
at least one processor; and
at least one memory communicatively coupled with the at least one processor and storing processor-readable code that, when executed by the at least one processor, is configured to cause the UE to:
receive, via medium access control (MAC) signaling, an indication to activate one or more transmission configuration indicator (TCI) states for the UE, wherein the indication triggers at least one of a measurement of a reference signal or a transmission of a measurement report for at least one TCI state of the one or more TCI states, wherein the reference signal or the transmission of the measurement report is triggered based at least in part on an association of a TCI state, from the at least one TCI state, with the reference signal or the measurement report;
receive the reference signal based at least in part on receiving the indication to activate the one or more TCI states; and
transmit the measurement report based at least in part on the indication triggering the transmission of the measurement report, wherein the measurement report indicates a measurement of the reference signal.

2. The UE of claim 1, wherein, to cause the UE to receive the indication to activate the one or more TCI states for the UE, the processor-readable code, when executed by the at least one processor, is configured to cause the UE to receive a MAC control element (MAC-CE) message that includes the indication to activate the one or more TCI states.

3. The UE of claim 1, wherein, to cause the UE to receive the indication to activate the one or more TCI states for the UE, the processor-readable code, when executed by the at least one processor, is configured to cause the UE to receive an indication of multiple TCI states that are to be activated for the UE.

4. The UE of claim 3, wherein the indication triggers at least one of a measurement of a reference signal or a transmission of a measurement report for each TCI state of the multiple TCI states.

5. The UE of claim 3, wherein the indication triggers at least one of a measurement of a reference signal or a transmission of a measurement report for each TCI state of a subset of TCI states of the multiple TCI states.

6. The UE of claim 1, wherein the at least one memory further stores processor-readable code configured to cause the UE to receive a set of activated TCI states prior to receiving the indication to activate the one or more TCI states, wherein the TCI state is not included in the set of activated TCI states, and
wherein, to cause the UE to receive the indication to activate the one or more TCI states for the UE, the processor-readable code, when executed by the at least one processor, is configured to cause the UE to receive the reference signal after a first amount of time relative to receiving the indication to activate the one or more TCI states, wherein the first amount of time is based at least in part on a scheduling offset value associated with the reference signal.

7. The UE of claim 6, wherein the at least one memory further stores processor-readable code configured to cause the UE to:
activate the TCI state after a second amount of time relative to receiving the reference signal, wherein the second amount of time is based at least in part on a processing time associated with receiving the reference signal.

8. The UE of claim 1, wherein the at least one memory further stores processor-readable code configured to cause the UE to receive configuration information configuring the association and the indication to activate the one or more TCI states in a same message.

9. The UE of claim 1, wherein the at least one memory further stores processor-readable code configured to cause the UE to receive configuration information configuring the association via radio resource control (RRC) signaling.

10. The UE of claim 1, wherein the association is based at least in part on a rule.

11. The UE of claim 1, wherein the measurement report is associated with an uplink shared channel, and wherein the at least one memory further stores processor-readable code configured to cause the UE to:
receive an indication of one or more transmission parameters to be used by the UE to transmit the measurement report on the uplink shared channel.

12. The UE of claim 11, wherein the indication of the one or more transmission parameters and the indication to activate the one or more TCI states for the UE are received in a same message.

13. A base station for wireless communication, comprising:
at least one processor; and
at least one memory communicatively coupled with the at least one processor and storing processor-readable code that, when executed by the at least one processor, is configured to cause the base station to:
transmit, to a user equipment (UE) via medium access control (MAC) signaling, an indication to activate one or more transmission configuration indicator (TCI) states for the UE, wherein the indication triggers at least one of a measurement of a reference signal or a transmission of a measurement report by the UE for at least one TCI state of the one or more TCI states, wherein the reference signal or the transmission of the measurement report is triggered based at least in part on an association of a TCI state, from the at least one TCI state, with the reference signal or the measurement report;
transmit the reference signal based at least in part on transmitting the indication to activate the one or more TCI states; and
receive the measurement report based at least in part on the indication triggering the transmission of the measurement report, wherein the measurement report indicates a measurement of the reference signal.

14. The base station of claim 13, wherein, to cause the base station to transmit the indication to activate the one or more TCI states for the UE, the processor-readable code, when executed by the at least one processor, is configured to cause the base station to transmit an indication of multiple TCI states that are to be activated for the UE.

15. The base station of claim 13, wherein the at least one memory further stores processor-readable code configured to cause the base station to transmit configuration information configuring the association and the indication to activate the one or more TCI states in a same message.

16. A method of wireless communication performed by a user equipment (UE), comprising:
receiving, via medium access control (MAC) signaling, an indication to activate one or more transmission configuration indicator (TCI) states for the UE, wherein the indication triggers at least one of a measurement of a reference signal or a transmission of a measurement report for at least one TCI state of the one or more TCI states, wherein the reference signal or the transmission of the measurement report is triggered based at least in part on an association of a TCI state, from the at least one TCI state, with the reference signal or the measurement report;
receiving the reference signal based at least in part on receiving the indication to activate the one or more TCI states; and
transmitting the measurement report based at least in part on the indication triggering the transmission of the measurement report, wherein the measurement report indicates a measurement of the reference signal.

17. The method of claim 16, wherein receiving the indication to activate the one or more TCI states for the UE comprises receiving a MAC control element (MAC-CE) message that includes the indication to activate the one or more TCI states.

18. The method of claim 16, wherein receiving the indication to activate the one or more TCI states for the UE comprises receiving an indication of multiple TCI states that are to be activated for the UE.

19. The method of claim 18, wherein the indication triggers at least one of a measurement of a reference signal or a transmission of a measurement report for each TCI state of the multiple TCI states.

20. The method of claim 18, wherein the indication triggers at least one of a measurement of a reference signal or a transmission of a measurement report for each TCI state of a subset of TCI states of the multiple TCI states.

21. The method of claim 16, further comprising receiving a set of activated TCI states prior to receiving the indication to activate the one or more TCI states, wherein the TCI state is not included in the set of activated TCI states, and
wherein receiving the reference signal comprises receiving the reference signal after a first amount of time relative to receiving the indication to activate the one or more TCI states, wherein the first amount of time is based at least in part on a scheduling offset value associated with the reference signal.

22. The method of claim 21, further comprising:
activating the TCI state after a second amount of time relative to receiving the reference signal, wherein the second amount of time is based at least in part on a processing time associated with receiving the reference signal.

23. The method of claim 16, further comprising receiving configuration information configuring the association and the indication to activate the one or more TCI states in a same message.

24. The method of claim 16, further comprising receiving configuration information configuring the association via radio resource control (RRC) signaling.

25. The method of claim 16, wherein the association is based at least in part on a rule.

26. The method of claim 16, wherein the measurement report is associated with an uplink shared channel, the method further comprising:
receiving an indication of one or more transmission parameters to be used by the UE to transmit the measurement report on the uplink shared channel.

27. The method of claim 26, wherein the indication of the one or more transmission parameters and the indication to activate the one or more TCI states for the UE are received in a same message.

28. A method of wireless communication performed by a base station, comprising:
transmitting, to a user equipment (UE) via medium access control (MAC) signaling, an indication to activate one or more transmission configuration indicator (TCI) states for the UE, wherein the indication triggers at least one of a measurement of a reference signal or a transmission of a measurement report by the UE for at least one TCI state of the one or more TCI states, wherein the reference signal or the transmission of the measurement report is triggered based at least in part on an association of a TCI state, from the at least one TCI state, with the reference signal or the measurement report;
transmitting the reference signal based at least in part on transmitting the indication to activate the one or more TCI states; and
receiving the measurement report based at least in part on the indication triggering the transmission of the measurement report, wherein the measurement report indicates a measurement of the reference signal.

29. The method of claim 28, wherein transmitting the indication to activate the one or more TCI states for the UE comprises transmitting an indication of multiple TCI states that are to be activated for the UE.

30. The method of claim 28, further comprising transmitting configuration information configuring the association and the indication to activate the one or more TCI states in a same message.
